(19) United States
(12) Patent Application Publication
(10) Pub. No.: US 2026/0120423 A1
(43) Pub. Date: Apr. 30, 2026

(54) ACCESSORY ADAPTATION TO MORPHOLOGICALLY DIFFERENT AVATARS

(71) Applicant: Roblox Corporation, San Mateo, CA (US)

(72) Inventors: Pratheba SELVARAJU, San Mateo, CA (US); Sheldon Paul ANDREWS, Montreal (CA); Hsueh-Ti LIU, Vancouver (CA); Victor B. ZORDAN, Riverside, CA (US); Adam Tucker BURR, Suffern, NY (US)

(73) Assignee: Roblox Corporation, San Mateo, CA (US)

(21) Appl. No.: 19/367,317

(22) Filed: Oct. 23, 2025

Related U.S. Application Data
(60) Provisional application No. 63/712,286, filed on Oct. 25, 2024.

(51) Int. Cl. G06T 19/20; G06T 13/40

(52) U.S. Cl. CPC G06T 19/20; G06T 13/40

(57) ABSTRACT

Some implementations include methods, systems, and computer-readable media for adapting accessories for morphologically different avatars. Such methods include obtaining garment information and target avatar information, the information including vertices, respective skinning weights, and associated bones, grouping the vertices into vertex clusters, initializing optimization matrices used to fit the garment onto the target avatar, and, after initializing the optimization matrices, updating the optimization matrices by performing at least one of: modifying the optimization matrices based on a first loss function calculated from aligning vertices in garment vertex clusters with corresponding vertices in target avatar vertex clusters; and modifying the optimization matrices based on a second loss function calculated from regularization based on centroids of bones of the garment vertex clusters and centroids of corresponding bones of the target avatar vertex clusters; and after updating the optimization matrices, fitting the garment onto the target avatar using the optimization matrices.

### CROSS-REFERENCE TO RELATED APPLICATIONS

This application claims priority under 35 U.S.C. § 119 (e) to U.S. Provisional Patent Application No. 63/712,286, entitled “ACCESSORY ADAPTATION TO MORPHOLOGICALLY DIFFERENT AVATARS,” filed on Oct. 25, 2024, the content of which is incorporated herein in its entirety.

### TECHNICAL FIELD

Implementations relate generally to computer graphics. More specifically but not exclusively, implementations relate to methods, systems, and computer-readable media to adapt a reference accessory designed for use with a human skeletal structure (or another original skeletal structure) where each bone has a semantic label and to optimize the accessory for a target avatar that may be morphologically different from a source avatar.

### BACKGROUND

In computer graphics, it may be helpful to take an accessory that is adapted to the morphology of one avatar and adapt the accessory to an avatar having a different morphology. For example, it may be helpful to provide an avatar that is a unicorn wearing a favorite t-shirt and shoes of a user one day, where the unicorn transforms into an octopus the next day. Virtual reality (VR) and augmented reality (AR), along with virtual experience platforms (such as gaming applications), bring these imaginative avatars to life. Adapting accessories like clothing to fit vastly different morphologies, such as a t-shirt designed for a unicorn being adapted to be worn by an octopus, is a significant challenge.

Many methods for adapting accessories between different avatars focus on human or humanoid avatars with similar skeletal structures. It is difficult to adapt such methods to non-humanoid forms or other avatars with substantially different morphologies. Even among humanoid avatars, significant deformations—like an avatar with spikes—can make adaptation difficult.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

According to one aspect, a computer-implemented method to fit a garment onto a target avatar is provided, the computer-implemented method comprising: obtaining garment information, the garment information including a plurality of garment vertices, a respective garment skinning weight for each vertex of the plurality of garment vertices, and a skeletal structure associated with the garment that defines source bones associated with the garment; obtaining target avatar information, the target avatar information including a plurality of target avatar vertices, a respective target avatar vertex skinning weight for each vertex of the plurality of target avatar vertices, and a skeletal structure of the target avatar that defines target bones of the target avatar; grouping the plurality of garment vertices into a plurality of garment vertex clusters corresponding to the source bones based on the garment vertex skinning weights; grouping the plurality of target avatar vertices into a plurality of target avatar vertex clusters corresponding to the target bones based on the target avatar vertex skinning weights; initializing optimization matrices for the source bones associated with the garment and the target bones of the target avatar used to fit the garment onto the target avatar, wherein the optimization matrices define transformations that include pose rotations that cause vertices in garment vertex clusters to map to corresponding vertices in corresponding target avatar vertex clusters; after initializing the optimization matrices, updating the optimization matrices by performing at least one of: modifying the optimization matrices based on a first loss function calculated from aligning vertices in garment vertex clusters with corresponding vertices in target avatar vertex clusters; and modifying the optimization matrices based on a second loss function calculated from regularization based on centroids of bones of the garment vertex clusters and centroids of corresponding bones of the target avatar vertex clusters; and after updating the optimization matrices, fitting the garment onto the target avatar using the optimization matrices.

Various implementations of the computer-implemented method are described herein.

In some implementations, the skeletal structure associated with the garment has a same morphology as the skeletal structure of the target avatar.

In some implementations, the skeletal structure associated with the garment has a different morphology as the skeletal structure of the target avatar.

In some implementations, the computer-implemented method further comprises, after the fitting, causing the target avatar to be displayed, wherein the target avatar is depicted as wearing the garment.

In some implementations, initializing the optimization matrices causes a front of the garment to correspond to a front of the target avatar.

In some implementations, aligning the vertices in the garment vertex clusters with corresponding vertices in the target avatar vertex clusters based on the first loss function comprises aligning the vertices in the garment vertex clusters onto corresponding vertices in the target vertex avatar clusters using one or more of rotation, scale, or shear transformations.

In some implementations, the first loss function is a chamfer loss function calculated as a sum of squared Euclidean distances from vertices in the garment vertex clusters to corresponding nearest neighbors in the target avatar vertex clusters and squared Euclidean distances from vertices in the target avatar vertex clusters to corresponding nearest neighbors in the garment vertex clusters.

In some implementations, the second loss function is a point-to-point loss function calculated based on absolute differences between vertices in the garment vertex clusters and corresponding vertices in the target avatar vertex clusters.

In some implementations, grouping the plurality of garment vertices into corresponding garment vertex clusters comprises, for source bones in the garment, adding garment vertices to garment vertex clusters corresponding to given source bones in response to determining that a respective skinning weight for a garment vertex with respect to a given source bone is greater than zero.

In some implementations, grouping the plurality of target avatar vertices into corresponding target avatar vertex clusters comprises, for target avatar bones in the target avatar, adding target avatar vertices to target avatar vertex clusters corresponding to given target bones in response to determining that a respective skinning weight for a target avatar vertex with respect to a given target bone is greater than zero.

In some implementations, updating the optimization matrices is performed iteratively two or more times, and wherein the updating is continued until a value of the first loss function is less than a first threshold value, a value of the second loss function is less than a second threshold value, or a combination thereof.

In some implementations, updating the optimization matrices is performed iteratively two or more times, and wherein the updating is continued until a computational budget for updating is exhausted, until a change in values of the optimization matrices between consecutive iterations falls below a threshold, or a combination thereof.

In some implementations, the computer-implemented method further comprises using Laplacian regularization, as conformal as possible regularization, or a combination thereof to reduce a strain energy associated with fitting the garment onto the target avatar.

In some implementations, fitting the garment onto the target avatar using the optimization matrices comprises applying the optimization matrices as affine transformations to map the source bones associated with the garment to the target bones of the target avatar.

According to another aspect, non-transitory computer-readable medium is provided. The non-transitory computer-readable medium has instructions stored thereon that, responsive to execution by a processing device, cause the processing device to perform or control performance of operations to fit a garment onto a target avatar. The operations comprise: obtaining garment information, the garment information including a plurality of garment vertices, a respective garment skinning weight for each vertex of the plurality of garment vertices, and a skeletal structure associated with the garment that defines source bones associated with the garment; obtaining target avatar information, the target avatar information including a plurality of target avatar vertices, a respective target avatar vertex skinning weight for each vertex of the plurality of target avatar vertices, and a skeletal structure of the target avatar that defines target bones of the target avatar; grouping the plurality of garment vertices into a plurality of garment vertex clusters corresponding to the source bones based on the garment vertex skinning weights; grouping the plurality of target avatar vertices into a plurality of target avatar vertex clusters corresponding to the target bones based on the target avatar vertex skinning weights; initializing optimization matrices for the source bones associated with the garment and the target bones of the target avatar used to fit the garment onto the target avatar, wherein the optimization matrices define transformations that include pose rotations that cause vertices in garment vertex clusters to map to corresponding vertices in corresponding target avatar vertex clusters; after initializing the optimization matrices, updating the optimization matrices by performing at least one of: modifying the optimization matrices based on a first loss function calculated from aligning vertices in garment vertex clusters with corresponding vertices in target avatar vertex clusters; and modifying the optimization matrices based on a second loss function calculated from regularization based on centroids of bones of the garment vertex clusters and centroids of corresponding bones of the target avatar vertex clusters; and after updating the optimization matrices, fitting the garment onto the target avatar using the optimization matrices.

Various implementations of the non-transitory computer-readable medium are described herein.

In some implementations, the first loss function is a chamfer loss function calculated as a sum of squared Euclidean distances from vertices in the garment vertex clusters to corresponding nearest neighbors in the target avatar vertex clusters and squared Euclidean distances from vertices in the target avatar vertex clusters to corresponding nearest neighbors in the garment vertex clusters.

In some implementations, the second loss function is a point-to-point loss function calculated based on absolute differences between vertices in the garment vertex clusters and corresponding vertices in the target avatar vertex clusters.

According to another aspect, a system is disclosed, comprising: a memory with instructions stored thereon; and a processing device, coupled to the memory, the processing device configured to access the memory and execute the instructions, wherein the instructions cause the processing device to perform or control performance of operations to fit a garment onto a target avatar, the operations comprising: obtaining garment information, the garment information including a plurality of garment vertices, a respective garment skinning weight for each vertex of the plurality of garment vertices, and a skeletal structure associated with the garment that defines source bones associated with the garment; obtaining target avatar information, the target avatar information including a plurality of target avatar vertices, a respective target avatar vertex skinning weight for each vertex of the plurality of target avatar vertices, and a skeletal structure of the target avatar that defines target bones of the target avatar; grouping the plurality of garment vertices into a plurality of garment vertex clusters corresponding to the source bones based on the garment vertex skinning weights; grouping the plurality of target avatar vertices into a plurality of target avatar vertex clusters corresponding to the target bones based on the target avatar vertex skinning weights; initializing optimization matrices for the source bones associated with the garment and the target bones of the target avatar used to fit the garment onto the target avatar, wherein the optimization matrices define transformations that include pose rotations that cause vertices in garment vertex clusters to map to corresponding vertices in corresponding target avatar vertex clusters; after initializing the optimization matrices, updating the optimization matrices by performing at least one of: modifying the optimization matrices based on a first loss function calculated from aligning vertices in garment vertex clusters with corresponding vertices in target avatar vertex clusters; and modifying the optimization matrices based on a second loss function calculated from regularization based on centroids of bones of the garment vertex clusters and centroids of corresponding bones of the target avatar vertex clusters; and after updating the optimization matrices, fitting the garment onto the target avatar using the optimization matrices.

Various implementations of the system are described herein.

In some implementations, the first loss function is a chamfer loss function calculated as a sum of squared Euclidean distances from vertices in the garment vertex clusters to corresponding nearest neighbors in the target avatar vertex clusters and squared Euclidean distances from vertices in the target avatar vertex clusters to corresponding nearest neighbors in the garment vertex clusters.

In some implementations, the second loss function is a point-to-point loss function calculated based on absolute differences between vertices in the garment vertex clusters and corresponding vertices in the target avatar vertex clusters.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram of an example system architecture that adapts accessories to morphologically different avatars, in accordance with some implementations.

FIG. 2A is a diagram illustrating vertices in a garment to be fitted onto a target avatar, in accordance with some implementations.

FIG. 2B is a diagram illustrating a cluster of vertices in a garment corresponding to a bone of an avatar, in accordance with some implementations.

FIG. 3A is an illustration of a target avatar, in accordance with some implementations.

FIG. 3B is an illustration of a possible garment, in accordance with some implementations.

FIG. 4A is a side view of a mesh corresponding to the target avatar, in accordance with some implementations.

FIG. 4B is a rear view of a mesh corresponding to the target avatar, in accordance with some implementations.

FIG. 5A is a view of a skeletal structure and corresponding skinning weights for a garment for a human avatar, in accordance with some implementations.

FIG. 5B is a view of a skeletal structure and corresponding skinning weights for a garment for a dog avatar, in accordance with some implementations.

FIG. 6A is an illustration of initializing orientation of a garment with respect to a target avatar, in accordance with some implementations.

FIG. 6B is an illustration of initializing orientation of vertices of a garment with respect to vertices of a target avatar, in accordance with some implementations.

FIG. 7A is an illustration of an initial iteration of fitting vertices of a target avatar and corresponding vertices of a garment vertex cluster, in accordance with some implementations.

FIG. 7B is an illustration of an early iteration of fitting vertices of a target avatar and corresponding vertices of a garment vertex cluster, in accordance with some implementations.

FIG. 7C is an illustration of a later iteration of fitting vertices of a target avatar and corresponding vertices of a garment vertex cluster, in accordance with some implementations.

FIG. 7D is an illustration of a final iteration of fitting vertices of a target avatar and corresponding vertices of a garment vertex cluster, in accordance with some implementations.

FIG. 8 is a flowchart illustrating a method to fit a garment onto a target avatar, in accordance with some implementations.

FIG. 9 is a flowchart illustrating aspects of a method to modify optimization matrices to improve a fit between a garment and a target avatar, in accordance with some implementations.

FIG. 10 is a diagram illustrating aspects of examples of morphology for a garment, a first target avatar, and a second target avatar, in accordance with some implementations.

FIG. 11 is a flowchart illustrating aspects of a method to align vertices in the garment with vertices in the target avatar, in accordance with some implementations.

FIG. 12A is a flowchart illustrating aspects of a method to group vertices in a garment to correspond to bones in a skeletal structure of a corresponding avatar, in accordance with some implementations.

FIG. 12B is a flowchart illustrating aspects of a method to group vertices in a target avatar to correspond to bones in a skeletal structure, in accordance with some implementations.

FIG. 13 is a flowchart illustrating aspects of a method to improve a fit of the garment onto the target avatar based on controlling strain energy, in accordance with some implementations.

FIG. 14 is a block diagram that illustrates an example computing device which may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be affected in connection with other implementations whether or not explicitly described.

The present disclosure is directed towards, inter alia, an approach that addresses a problem in computer graphics of taking a garment or another accessory that is designed for use on one avatar and transforming the garment so that the garment or other accessory may be used on another avatar. The approach can be extended to avatars with arbitrary shapes and different morphologies from one another.

There is a growing demand for avatars with arbitrary shapes and morphed topologies, reflecting aspects of user creativity. Accessories are useful for giving avatars humanoid traits and personality, enhancing digital experiences in computerized environments such as gaming environments and virtual reality (VR) industries. Therefore, enabling users to adapt accessories from one avatar to another, regardless of morphological differences between avatars, is useful/valuable.

Despite other advances in three-dimensional (3D) modeling, current techniques lack a mechanism to seamlessly adapt accessories to avatars with varying topologies, morphologies, or other significant mesh deformations. Directly adapting an accessory from one topology (or morphology) to another using current techniques often results in poor fitting of the accessory.

The techniques described herein may begin with a source avatar mesh (which may correspond to an accessory or garment) with a known skeletal structure and skinning weights and a target avatar mesh with a different skeletal structure and topology. The target avatar mesh may have a skeletal correspondence to the source mesh. Such a skeletal correspondences permits the approach to adapt deformable or non-deformable accessories from the source to the target avatar.

A successful adaptation may be achieved by fitting the accessory onto the avatar such that the strain energy of the accessory is minimized or otherwise reduced, thereby adapting the accessory to an avatar for fit and style. As discussed herein, a strain energy may be representative of internal restorative forces and may be minimized or otherwise reduced when a fit is a good fit, in that a fitted accessory that fits well tends to have low internal restorative forces.

For example, when fitting a garment onto an avatar, the techniques may begin by grouping and/or splitting vertices of the garment into garment vertex clusters based on skinning weights of skeletal structures of an avatar associated with the garment. Likewise, the techniques may include grouping and/or splitting vertices of the target avatar into target avatar vertex clusters based on skinning weights of skeletal structures of the target avatar. Optimization matrices are initialized for each bone part based on a pose rotation between a source bone of the garment for the bone part and a corresponding target bone of the target avatar for the bone part.

A fit between vertices in the garment and corresponding vertices in the target avatar may be solved based on two loss functions. The first loss function may be a chamfer loss defined between points on the garment and points on the target avatar. The second loss function may be a loss function based on regularizing orientation of the garment based on point-to-point loss (such as an L1 norm) based on relative positions of centroids of bones of an avatar associated with the garment and centroids of corresponding bones of the target avatar.

A problem addressed herein is adapting accessories like clothing to fit vastly different morphologies. An example of such a task is adapting a t-shirt designed for a unicorn avatar to be worn by an octopus avatar. Such adapting is a challenging task. Significant deformations to an avatar, such as adding spikes to an avatar, can make adaptation difficult. Despite advances in 3D modeling, current techniques lack a mechanism to easily adapt accessories to avatars with varied topologies or significant mesh deformations. Directly adapting an accessory from one topology to another using current techniques often results in poor fitting.

To address the issue of adapting accessories, some implementations begin with the generalized style adaptation and fitting of accessories on registered pose avatars with humanoid structures. Such humanoid structures may feature multiple arms and/or legs. The approach can be extended to other avatars with arbitrary shapes and morphologies. Given a source avatar mesh (which may correspond to a garment or another accessory) with a known skeletal structure and skinning weights, and a target avatar mesh with a different skeletal structure and topology (but with skeletal correspondence to the source mesh), it may be possible to adapt any deformable or non-deformable accessory to fit to the target avatar.

The adaptation of the accessory may be achieved by fitting the accessory onto the target avatar such that the strain energy of the accessory is minimized or otherwise reduced. When such strain energy is minimized/reduced, there is a uniform triangle scale and no major stretch or compression of triangles in the accessory mesh. The bending energy for fit and style adaptation has minimal/reduced angle changes between adjacent triangles, such that bending energy is smooth, while adapting an accessory or garment to a target avatar for fit and style. The amount of stretch/bending allowed for each triangle can be different for different parts of the mesh, based on the materials. For instance, a stretchy material could allow for stretching, while a rigid material region would be more resistant to bending/stretching.

For example, if a shirt is being fitted to the neck of a dog avatar, if the collar of the shirt is fitted to the neck of the dog avatar, then the collar triangles of the shirt may become stretched between the neck and torso of the dog avatar. In such an example, this issue provides for a fit of the shirt to the surface of the dog avatar, but with a non-uniform and high strain deformation.

This issue is a problem addressed in various implementations. Various implementations also address other issues with the overall fitting problem between morphologies. When fitting a body part to another body part of a garment when the garment is adapted to a target avatar, such as fitting the arm of a shirt to the torso of the shirt, the fit may be such that the arm is turned and/or rotated by 90 degrees to cause appropriate correspondence. For example, adapting an arm for a humanoid avatar to an arm of a dog avatar may involve this issue of rotation. If this issue occurs, the issue may make the fit of the garment onto the target avatar be still a good fit but have high bending energy. Such a problem is addressed herein as well in various implementations.

Various implementations take as input a reference human accessory (e.g., a garment in some implementations, though other types of accessories may use similar techniques in other implementations) associated with an avatar having vertices and a skeletal structure. The skeletal structure (including bone information used for rigging, which has parent-child relationships) is associated with a semantic label for each bone, along with corresponding skinning weights (the influence of a bone on each vertex). The implementations also take as input similar information for a target avatar, including vertices, a skeletal structure with semantic labels, and corresponding skinning weights.

The target avatar may be morphologically different from the source avatar to which the reference human accessory originally corresponds. For example, a source avatar onto which the shirt was originally fit may be a dog avatar, and a target avatar may be an octopus avatar. The octopus avatar may have its own skeletal, semantic labels for its bones and skinning weight information for its vertices. It may be possible to optimize/adapt the accessory that was originally fit onto the dog avatar to generate an output accessory (garment) that may fit the target avatar body parts well, as defined by minimizing various loss functions, details of which are discussed herein.

For example, there may be a source garment, such as a shirt. The shirt may have originally been fitted onto a dog avatar. The target avatar may be an octopus avatar, and implementation may adapt a fit of the shirt garment onto the octopus avatar.

There may be no available groundtruth information for how a shirt fits onto the octopus avatar. In various implementations, the fitting may be driven by the skeletal information provided (e.g., the available input). All/most limbs of the eight limbs (of the octopus avatar) may be marked semantically as being hands. Then the optimization/adaptation modifies the original shirt to create a shirt with eight sleeves (each sleeve corresponding to a limb of the octopus avatar) and fits the modified shirt to the octopus avatar. In the case of a dog avatar, if all limbs of the four limbs (of the dog avatar) are marked as hands, then modifying the shirt involves creating an additional set of sleeves such that the shirt also fits the hind legs/limbs of the dog avatar.

Naive fitting of the entire garment (accessory) to the avatar may not work well because of pose and skeletal variations for each bone part. A solution according to various implementations is to group the bone parts and fit each bone part as a joint optimization problem.

This approach for fitting the accessory solves two problems. First, the approach handles the fitting itself in an effective manner, achieving a high-quality fit as measured using a loss function. The other problem solved is the adaptation to any skeletal structure with duplicate semantic labels. By using such duplicate semantic labels, a correspondence can be established between bone parts that permits successful fitting. The techniques address how each fitted part can seamlessly be integrated into one garment when fit onto the target avatar.

There are at least two example parts to the solution provided by various implementations. A first part is the fitting of garment onto an avatar that has the same skeletal structure and no duplication of semantic labels of bones using an affine transformation. A description follows in detail of the steps in a technique for the first part.

Such a technique may include the following aspects. For example, the technique may begin with certain initial assumptions. For a shirt garment, as an example accessory, various implementations may semantically label the bone parts for an associated avatar as head, torso, left upper arm, left lower arm, right upper arm, and right lower arm. For a dog avatar, as an example target avatar, various implementations may semantically label the bone parts as head, neck, torso, left upper arm, left lower arm, left lower foot, left toe, right upper arm, right lower arm, right foot, and right toe. The semantic labels may help establish correspondences between portions of the shirt and the target dog avatar. Because a dog avatar has four limbs, the bone parts may reflect this when used. For example, a dog avatar could be semantically labeled as having front legs that correspond to human arms and back legs that correspond to human legs, or as having front and back legs that correspond to human legs. These different correspondences may yield different garment transfer results.

Another assumption is that skinning weights for a given bone (whether of an associated avatar for a garment/accessory or of a target avatar) corresponds to all vertices with a weight greater than zero corresponding to that bone. A skinning weight refers to the amount of influence a particular bone has over a mesh's vertices, which determines how the mesh deforms when the bone moves during animation. The skinning weight may range from 0 or 0%, which indicates no influence, to 1 or 100%, which indicates a full or maximum influence. Thus, as long as the skinning weight for a given vertex with respect to a given bone is greater than 0 or 0%, this indicates that a given vertex is affected to at least some extent by the corresponding bone. Having such a skinning weight greater than 0 for a vertex for a corresponding bone is taken as meaning that vertex belongs in a vertex cluster associated with the corresponding bone.

In an example implementation, a shirt may be adapted to fit onto a dog avatar. The shirt may originally have a form that fits the shirt onto a humanoid avatar. The dog avatar may be a target avatar onto which the shirt is to be fitter. In such an implementation, vertices of the shirt are referred to as Vs. Vertices of the dog avatar are referred to as Vd.

Some implementations group the vertices of the garment (here, a shirt) and the target avatar (here, a dog avatar) based upon the skinning weights of each bone in an associated avatar for the garment and each bone in the target avatar. For example, with a default avatar body and animation rig (such as for a humanoid avatar) there may be fifteen different vertex clusters, each corresponding to a bone in the humanoid avatar. When grouping vertices, an initializing occurs by initializing a cluster for bone_i for a value of i for each bone identifier, where a bone identifier is a number corresponding to a bone, where each bone has a corresponding semantic label, such as a torso.

For each garment vertex (Vs_i) in vertices Vs of the shirt, for each bone (b) in skeletal bones corresponding bones of an associated avatar for the garment, if skinning_weight (Vs_i, b)>0, then cluster [b].add (Vs_i) (that is, that vertex (Vs_i) is added to the given cluster for bone b). As an example, for vertices in a torso for the shirt (Vs_i where skinning_weight (Vs_i, torso)>0), vertices in the shirt are added to the cluster of torso vertices for the shirt where the corresponding torso skinning weights for such vertices are greater than 0.

For example, there may be a set of original vertices of the shirt (with sleeves). There may be another set of vertices that are extracted, grouped, and/or clustered that include only the torso vertices of the shirt. Given that a shirt usually only covers certain portions of the avatar, usually only certain parts of the avatar have vertices in the shirt assigned to the relevant vertex clusters. For example, as noted above, the shirt may correspond to clusters for head, torso, left upper arm, left lower arm, right upper arm, and right lower arm, but there may be bones of the humanoid avatar with no associated vertices in the cluster (bones with no skinning weights greater than 0). For example, a shirt may not have any vertices corresponding to a lower leg of the humanoid avatar.

A similar grouping may occur for the target avatar, such that for each target avatar vertex (Vd_i) in vertices Vd of the dog, for each bone (b) in skeletal bones corresponding bones of the dog, if skinning_weight (Vd_i, b)>0, then cluster [b].add (Vd_i) (that is, that vertex (Vd_i) is added to the given cluster for bone b). As an example, for vertices in a torso for the dog (Vd_i where skinning_weight (Vd_i, torso)>0), vertices in the dog are added to the cluster of torso vertices for the dog where the corresponding torso skinning weights for such vertices are greater than 0.

After the grouping of the vertices (for the garment and the target avatar) into vertex clusters, various implementations take various operations to prepare for optimization. N affine matrices are initialized for N different bone parts (MB_i). Specifically, for each bone (b_i) in skeletal bones: MB_i=Zeros (4,4). That is, the affine matrices are four by four matrices, where each element is initially zero. M affine matrices are also initialized for N different seam parts (MS_i). Specifically, for each seam part (s_i): MS_i=Zeros (4,4). Again, the matrices are four by four matrices, where each element is initially zero. Such bones correspond to vertices that have been grouped into vertex clusters associated with bones, and such seams provide ways to attach the various parts of an accessory together to one another.

The definition of bones versus seams is based on the skinning weights associated with each vertex. This skinning weight “W” is a matrix with a size based on a number of vertices by a number of bones. Each entry W [vertexID, boneID] indicates the amount of influence of a bone having boneID on a vertex having vertexID, normalized between 0 and 1.

Bone vertices are defined on vertices where the per-row-maximum in W is larger than a user-specified threshold, such as 0.75. Vertices that are not bone vertices are defined as seam vertices.

After the affine matrices (for the bone parts and the seam parts) are ready, for each part, to counter to pose variation, the optimization matrices are initialized with a pose rotation. For example, MB_i=Rotation (source bone, target bone). A rotation is a linear transformation, and aspects of providing an affine matrix that provides a rotation is discussed further, herein. In the present example, the source torso is initially upright (given that the source torso corresponds to a human avatar torso), and target torso is horizontal (given that the target torso corresponds to a dog avatar torso).

Because of the difference in orientation, the pose rotation reflects this difference. The pose rotation makes the torso cluster of the shirt rotate to the horizontal torso cluster of the dog. The pose rotation is also carried out in a way that the front of the garment and the front of the target avatar are aligned with one another. Without this, the front of the shirt may be oriented to the back of the dog, as an example.

After preparing the rotations in the optimization matrices, the chamfer loss is optimized/reduced for each part ( [symbol] _{chamfer}) to align points on the garment to points on the avatar. Regularization also occurs based on point-to-point loss on centroids of bones of the garment and bones of the avatar ( [symbol] _{L1}).

For example, optimizing/reducing the chamfer loss is based on the following Equation 1. Given two point sets P and Q, the chamfer loss is defined as the sum of the distances from each point in P to its nearest neighbor in Q, plus the sum of the distances from each point in Q to its nearest neighbor in P.

For example, P and Q in Equations 1, 2, and 3 may refer to the point sets being compared (the point set of a current garment vertex cluster and the corresponding point set of a current target avatar vertex cluster, respectively). The chamfer loss is a metric used to measure the similarity between two sets of points, such as point clouds in computer vision and 3D graphics. A chamfer loss is defined as the sum of the squared nearest-neighbor distances between the two point sets. The lower the chamfer loss, the more similar the point clouds are. For two point clouds P and Q, the chamfer loss is defined as:

$${ℒ}_{chamfer} ( P , Q ) = \frac{{\sum }_{p ∈ P} {min}_{q ∈ Q} {‖ p - q ‖}_{2}^{2}}{\vert P \vert} + \frac{{\sum }_{q ∈ Q} {min}_{p ∈ P} {‖ q - p ‖}_{2}^{2}}{\vert Q \vert} . \qquad ( Equation 1 )$$

Here, the first term computes the squared distance from each point in point cloud P to its nearest neighbor in point cloud Q. The second term computes the squared distance from each point in point cloud Q to its nearest neighbor in point cloud P. The distances are often based on the Euclidean L2 norm.

The (symmetric) chamfer loss works by calculating a two-way sum of distance. For every point in the first point cloud, find the closest point in the second point cloud and record the distance. For every point in the second point cloud, find the closest point in the first point cloud and record the distance between such points. Then, sum all the recorded squared distances. If the point clouds have different numbers of points or varying densities, the loss can be normalized by dividing each term by the size of its corresponding point set. The two-way sum is the “symmetric” chamfer distance. The original chamfer distance only has a one-way sum. These equations are the objective function to define whether some points of interest (e.g., a centroid of the mesh and a centroid of the garment) are at similar locations. Using this approach tries to ensure, for instance, a t-shirt is close to the body of a target character.

Likewise, optimizing/adapting based on point-to-point loss on the centroid of each part is based on the following Equations 2 and 3. Equation 2 defines an L1 norm, and Equation 3 defines aspects of calculating Equation 2. For example, an L1 norm is also known as a Manhattan Distance or Taxicab Distance, between two points (or vectors) and is calculated by summing the absolute differences of the corresponding components. Given two points, the L1 norm finds the difference between the corresponding coordinates of the two points, takes the absolute value of each of these differences, and sums all of the absolute differences.

$${ℒ}_{L 1} ( P , Q ) = \frac{1}{n} {\sum }_{i = 1}^{n} {‖ {p}_{i} - {q}_{i} ‖}_{1} . \qquad ( Equation 2 )$$

$${‖ {p}_{i} - {q}_{i} ‖}_{1} = {\sum }_{j = 1}^{d} \vert {p}_{i}^{j} - {q}_{i}^{j} \vert . \qquad ( Equation 3 )$$

$$Total loss = {ℒ}_{chamfer} ( P , Q ) + {ℒ}_{L 1} ( P , Q )$$

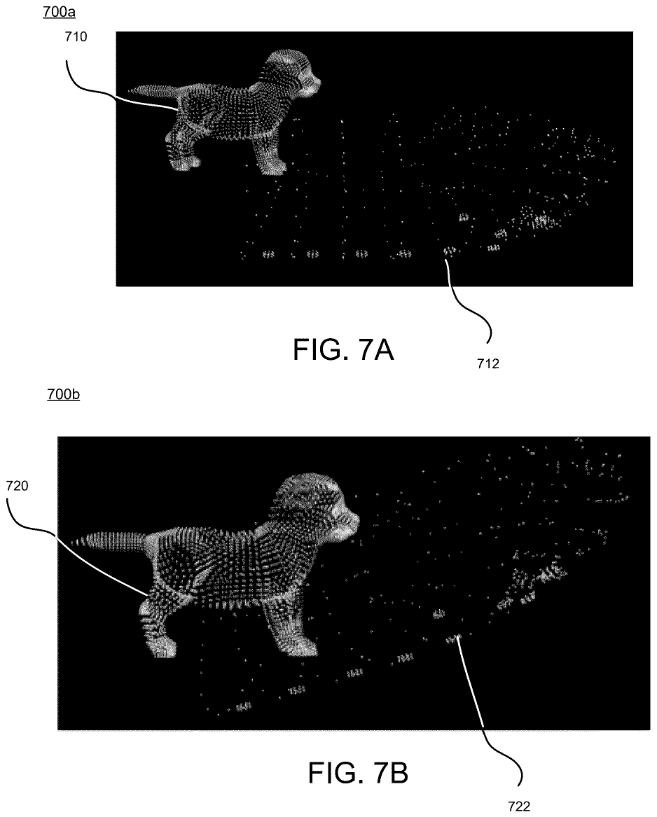

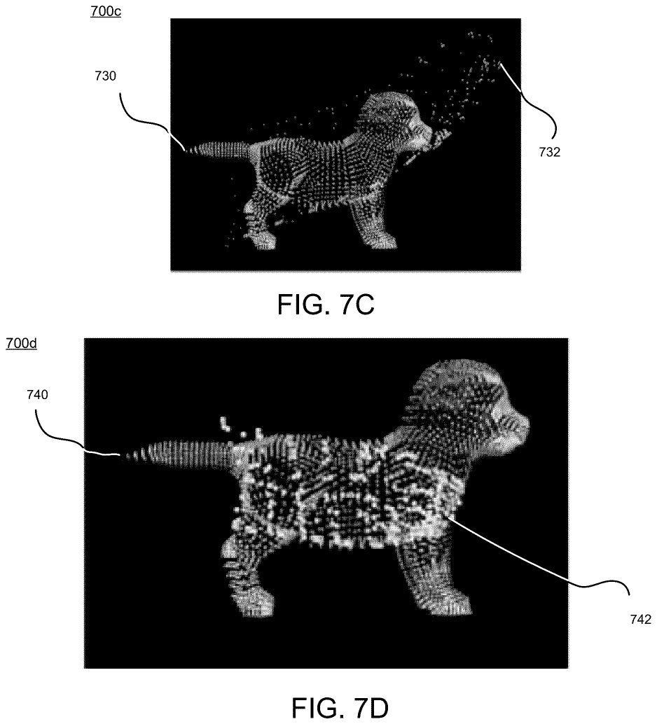

For example, using the chamfer loss, a torso of a shirt is slowly optimized/adapted to fit a torso of a dog. In a first iteration, the fit may be rough. In middle iterations, the fit gradually gets better. In the final fit, the fit is good. Further examples and aspects of this process are illustrated and discussed at FIGS. 7A-7D.

When using the chamfer loss, the fitting includes aligning points on the garment with points on the avatar using rotation, scale, and shear transformations. When using the point-to-point loss, the centroids of the bones are aligned with one another. By adding these loss functions together, it may become possible to adjust the rotation, scale, and shear as linear transformations and further use translation as a feature of an affine transformation matrix to achieve the best fit possible.

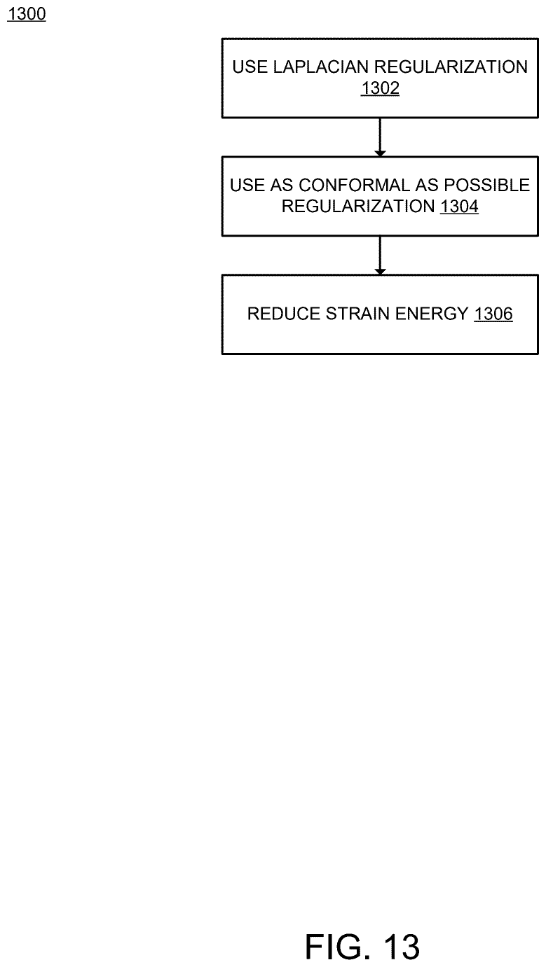

The rough fit as discussed above may give a good initial fit of the accessory onto the target avatar. In an example, the collar bone of the shirt does not fit very well onto the neck of the dog avatar. By constraining the collar vertices to the neck in the rough fit, the shirt gets deformed such that the triangles are scaled non-uniformly and stretched. A technique is to use Laplacian regularization to make the deformation smooth. Another technique is to use as conformal as possible (ACAP) regularization to have minimal/reduced triangle deformation to have minimal/reduced strain and bending energy. Additional aspects of these approaches are discussed with respect to FIG. 13.

A second part of fitting (in addition to fitting between a garment with an associated avatar with a same skeletal structure and no duplicate semantic labels) may be the fitting of garment onto an avatar that has a different skeletal structure or duplication of semantic labels of bones. There may still be an assumption that the source bone semantic label has a correspondence in the target avatar bone semantic label. In some implementations, there may be various operations to achieve a good fit of a garment onto an avatar that has a different skeletal structure or duplication of semantic labels of bones.

In one technique for this second part, the target avatar vertices are grouped into different clusters based on the correspondence/influence of each bone in the target avatar. Instead of 1:1 fitting from source avatar bone to target avatar bone, the technique for the second aspect includes 1:K fitting, where K is the number of duplicate semantic labeling of bone (e.g., a single left lower arm of a shirt, and corresponding two left lower arms in a dog avatar/four left lower arm in an octopus avatar). The seamless integration of the parts by mapping one source bone to multiple target bones is an aspect of these implementations.

In various implementations, the technical solution may include other aspects. For example, the technical solution may specify how and where to poke a hole in the garment. The technical solution may also specify how to integrate such a new part into the garment.

The technical solution(s) may also specify how to remove vertices from the region on intersections between the torso and the new bone vertices. The technical solution(s) may also specify how to insert the fitted limb part into the region. The technical solution(s) may also specify how to optimize/adapt for no intersection of a triangle between different body parts.

Current accessories (e.g., garments) are used in layered clothing in a virtual environment, such as a computerized gaming environment. The artists create a “cage” (including control points) that has a mapping to the accessory (point-to-point correspondence) to fit the accessory correctly onto the target avatar. Current avatars are humans and humanoids with fifteen joint parts (e.g., humanoids each having different semantic labels (head, torso, upper leg, etc.)). Avatars may have other numbers of joint parts while remaining humanoid.

In some implementations, if new avatars with different skeletal structures (morphologically different), or the same skeletal structure but duplicated semantic labels (an avatar of a dog with all four limbs labeled as arm) are provided, various implementations can fit and/or adapt the accessory to the new avatar.

In various implementations, several other beneficial aspects may be provided. There is no mandatory cage creation (otherwise including manual labor that is elaborate and time consuming) for any new character/avatar. If new avatars are not restricted to human/humanoid avatars (such as those with fifteen joint parts), there is no obligation for artists to create new garments/accessories. The accessory can be created from the existing humanoid template to fit to morphologically different avatars.

Other benefits provided by implementations may include automatic accessory creation. With a given skeletal information and semantic label for each vertex (that matches a template/reference skeletal information), the implementations are adaptable to creating a new three-dimensional (3D) garment/accessory.

Some implementations provide ways to take a reference human accessory (e.g., a garment) having an associated avatar with a corresponding skeletal structure with a semantic label for each bone, along with skinning weights and a morphologically different avatar. Because there is no groundtruth data available about how the accessory fits on the avatar, the optimization/adaptation process modifies the accessory to fit the accessory onto the avatar as well as possible based on certain loss functions. The garment and the avatar may each have certain bone parts and vertices. The bones may have certain skinning weights.

The techniques also include grouping the vertices of the garment and the avatar based on the skinning of each bone. This extracts vertices of the entire garment as well as clusters for individual bones. After splitting the vertices, affine matrices for bone parts and seam parts are initialized as four by four matrices where each element is zero.

The bone part matrices are initialized with rotations from the source torso to the target torso. The fit is improved by solving for a fit based on chamfer loss and regularizing orientation of the garment based on point loss based on centroids of bones of the garment and corresponding bones of the target avatar.

By performing such optimizing iteratively, the garment may be slowly optimized/adapted to fit the corresponding portion of the target avatar. The optimization/adaptation provides an initial fit. The fit may be further improved using Laplacian regularization and/or as conformal as possible regularization. There may also be techniques that permit fitting a garment to an avatar which has a different skeletal structure or duplication of semantic labels of bones.

Currently, accessories (such as garments) are used as layered clothing in virtual environments. With the techniques described herein, when creating new avatars with different skeletal structures (morphologically different avatars) or the same skeletal structure but duplicated semantic labels (for example, a human avatar has two legs while a dog has four legs), the techniques can fit and/or adapt the accessory to the new avatar.

Hence, using the techniques described herein may reduce the obligation for cage creation for a new avatar, which may otherwise involve elaborate, time consuming manual labor. For example, accessories can be created from an existing humanoid template to fit to morphologically different avatars. Also, with a given skeletal information and semantic label for each vertex (corresponding to a template/reference skeletal information) the solution is adaptable to creating a new 3D garment/accessory.

Currently, accessories (for example, garments) are used in layered clothing in certain virtual environments. Artists may create a “cage” (including control points) which has a mapping to the accessory (point to point correspondence) to fit the accessory correctly onto the avatar. Current avatars are humans and humanoids, in some implementations having 15 joint parts, each having different corresponding semantic labels.

With the implementations, if a new avatar is created with different skeletal structure (morphologically different) or a same skeletal structure but with duplicated semantic labels (for example, a dog with all of its limbs are considered arms), the implementations can fit/adapt the accessory onto the new avatar. These implementations provide the benefits of obviating the task of cage creation (which may otherwise involve elaborate and time consuming manual labor) for a new avatar.

Furthermore, if new avatars are not restricted to human/humanoid avatars having 15 joint parts as discussed above (or even restricted to being humanoid avatars), various implementations may avoid the requirement for artists to create new garments/accessories. The accessory can be created from the existing humanoid template to fit to morphologically different avatars. Thus, various implementations provide for automatic accessory creation, such that with a given skeletal information and semantic label for each vertex (that matches a template/reference skeletal information), the implementations are adaptable to creating a new 3D garment/accessory.

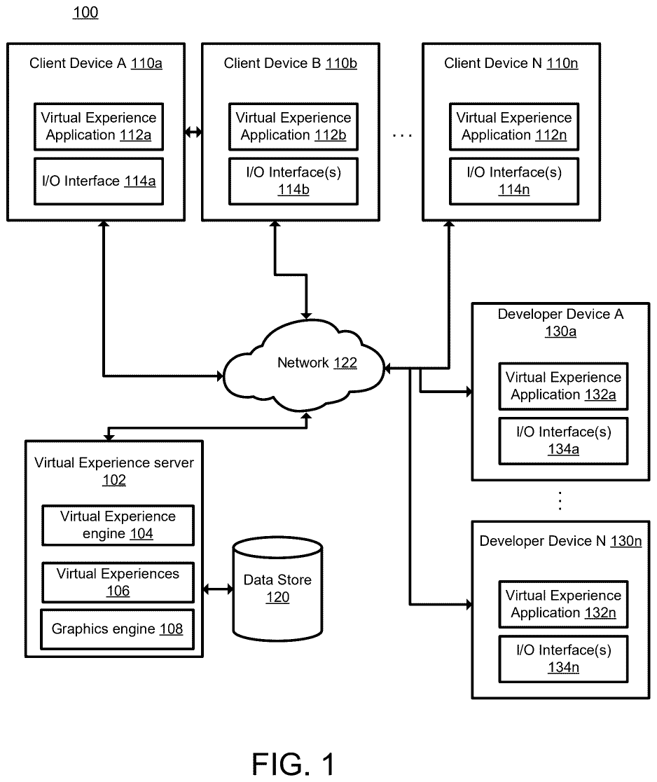

FIG. 1 is a diagram of an example system architecture 100 that adapts accessories to morphologically different avatars, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

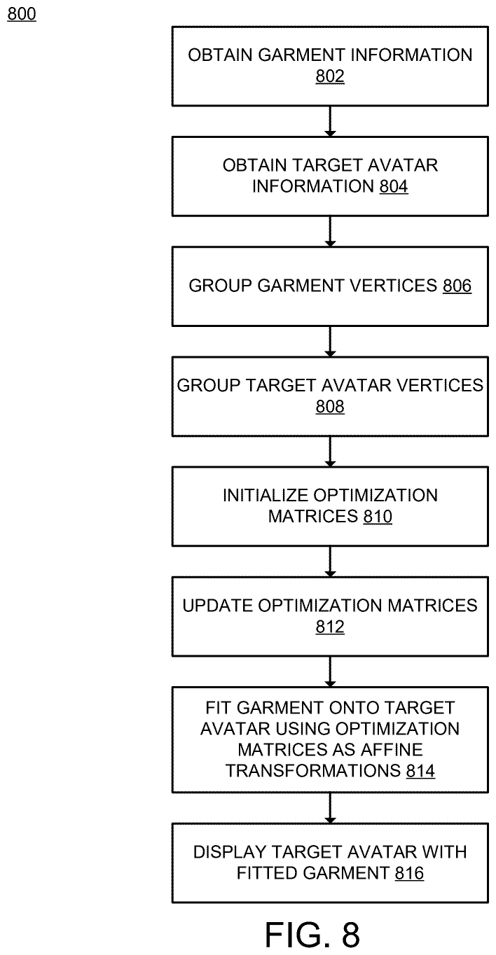

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 and/or some other device(s)/component(s) of FIG. 1 may perform one or more of the operations described below in connection with the flowcharts shown in FIGS. 8-9 and 11-13, and/or other operations described herein. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata (e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.).

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata (e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc.). In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.” In some contexts, a “user” may be a system administrator or other entity that may have privileges, roles, etc. associated with the virtual experience server 102 and which may be different from or additional to those of end users, developers, or other types of users.

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience. References herein to games and related functionality are merely examples for purposes of describing and illustrating various features, and such features can be adapted for other types of virtual environments that do not necessarily involve games.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102, hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience application 112 and/or to other component(s) of client device 110 capable of performing virtual experience engine functions. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, for example, dimensions (height, width, girth, etc.); body type; movement style; number/type of body parts; proportion (e.g., shoulder and hip ratio); head size; etc. is provided as illustration. In some implementations, any number of client devices 110 may be used.

One or more characters (also referred to as an “avatar” or “model” herein) may be associated with a user where the user may control the character to facilitate a user's interaction with the virtual experiences 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types (e.g., shirts, pants, etc.), the online virtual experience platform may provide users with access to simplified 3D virtual object models that are represented by a mesh of a low polygon count (e.g., between about 20 and about 30 polygons).

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device” or other analogous terminology. In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, application, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 112 may be an online virtual experience server application for users to build, create, edit, or upload content to the online virtual experience server 102 as well as interact with online virtual experience server 102 (e.g., engage in virtual experiences 106 hosted by online virtual experience server 102). As such, the virtual experience application 112 may be provided to the client device(s) 110 by the online virtual experience server 102. In another example, the virtual experience application 112 may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application 132 may be a web application (e.g., an application that operates in conjunction with a web browser) that can access, retrieve, present, or navigate content (e.g., virtual character in a virtual environment, etc.) served by a web server. In another example, the virtual experience application 132 may be a native application (e.g., a mobile application, app, virtual experience program, or a gaming program) that is installed and executes local to developer device 130 and allows users to interact with online virtual experience server 102. The virtual experience application 132 may render, display, or present the content (e.g., a web page, a media viewer) to a user. In an implementation, the virtual experience application 132 may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application 132 may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application 132. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs) and thus is not limited to use in websites.

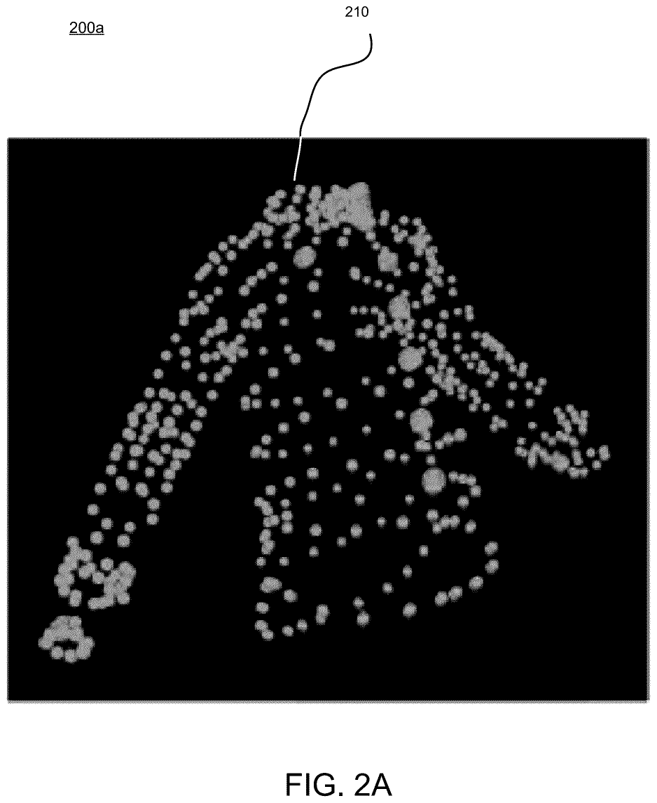

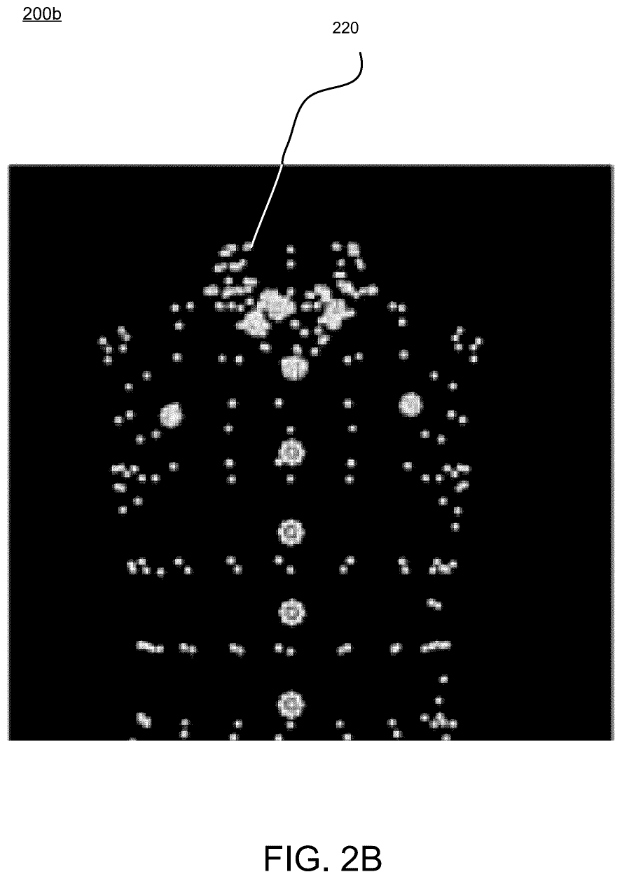

FIG. 2A is a diagram illustrating vertices 210 in a garment to be fitted onto a target avatar, in accordance with some implementations. For example, the vertices 210 may be vertices of a long-sleeved shirt, such that the long-sleeved shirt is initially provided in a form that may be fit as an accessory onto a humanoid avatar. While not illustrated in FIG. 2A, the vertices 210 may correspond to a variety of garment vertex clusters. For example, the garment vertex clusters may include a torso, and a left arm (divided into upper arm and lower arm/hand) and a right arm (divided into upper arm and lower arm/hand), etc. of the shirt. The garment vertex clusters may also include seams of the shirt (for example, a left upper arm may be joined to a torso at a seam located at a left shoulder of the shirt).

The shirt may include vertices 210 that correspond to various relevant bones in the humanoid avatar. For example, the bones of a humanoid avatar that may be relevant for a shirt may be the head, the torso, the left upper arm, the left lower arm, the right upper arm, and the right lower arm. The humanoid avatar may include other bones (such as leg bones) that are not relevant or less relevant to the fitting of the shirt, in that the shirt does not have any vertices 210 associated with or influenced by these bones. Such a lack of association and influence is determined because, for these irrelevant bones, a skinning weight for the irrelevant bones for the vertices in the garment 210 has a value of 0 (in that these bones have no influence on the corresponding vertices).

FIG. 2B is a diagram illustrating a cluster of vertices 220 in a garment corresponding to a bone of an avatar, in accordance with some implementations. For example, the vertices 220 illustrated in FIG. 2B are those vertices 220 extracted and grouped from vertices 210 that correspond to the torso bone of the associated avatar corresponding to the garment. A similar extraction and grouping may occur for the target avatar, such that the target avatar has target avatar vertices corresponding to the entire target avatar, and clusters of such target avatar vertices are grouped as corresponding to particular bones in the target avatar.

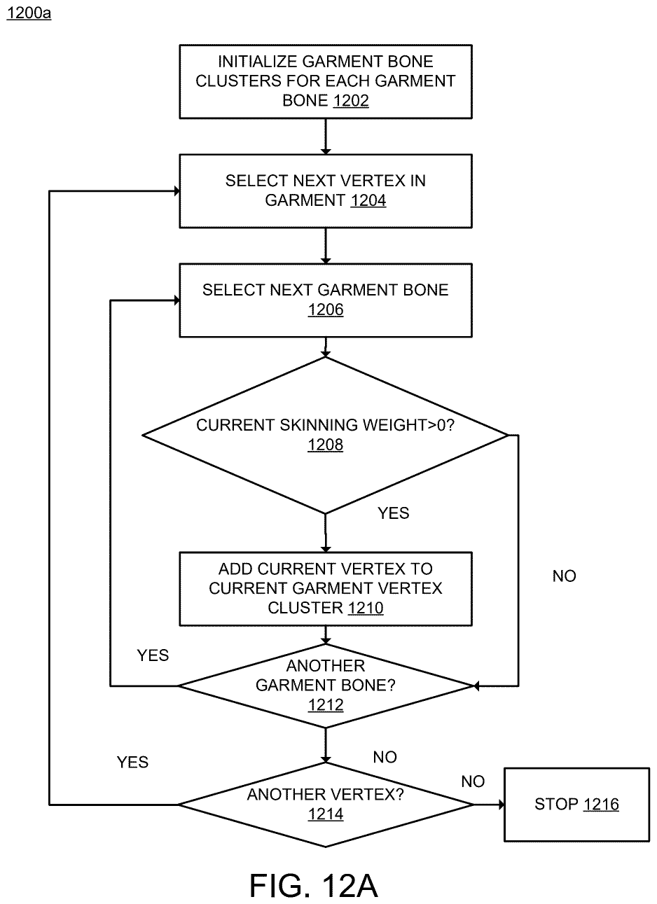

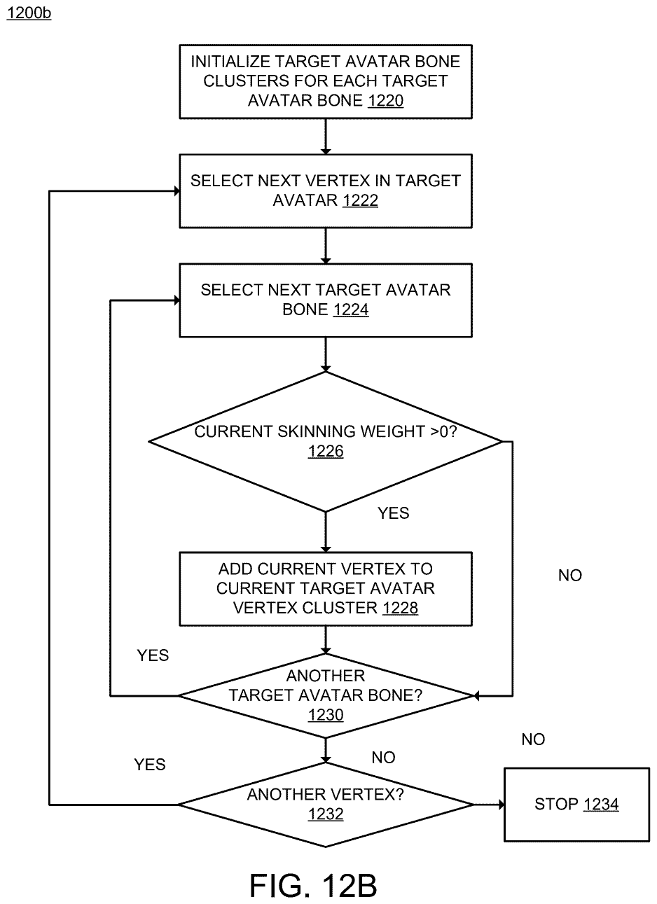

Additional details of grouping garment vertices are presented with respect to FIG. 12A. Additional details of grouping target avatar vertices are presented with respect to FIG. 12B.

Hence, it is possible to deform these vertices 220 in the torso separately from other portions of the garment. This is helpful because the deformation used to fit vertices from the torso portion of a garment (such as a shirt) may be different from the deformation used to deform vertices from another portion such as an upper arm. Once vertices from individual portions of the garment are fitted onto the target avatar, additional operations may be implemented to fit the points in clusters together, such as at seam portions. A cluster here means a piece of geometry enclosed by a set of closed seam vertices. For instance, a head can be a cluster with neck vertices being its seam. Performing fitting within clusters may help ensure that seams are more aligned, which translates to better visual quality results.

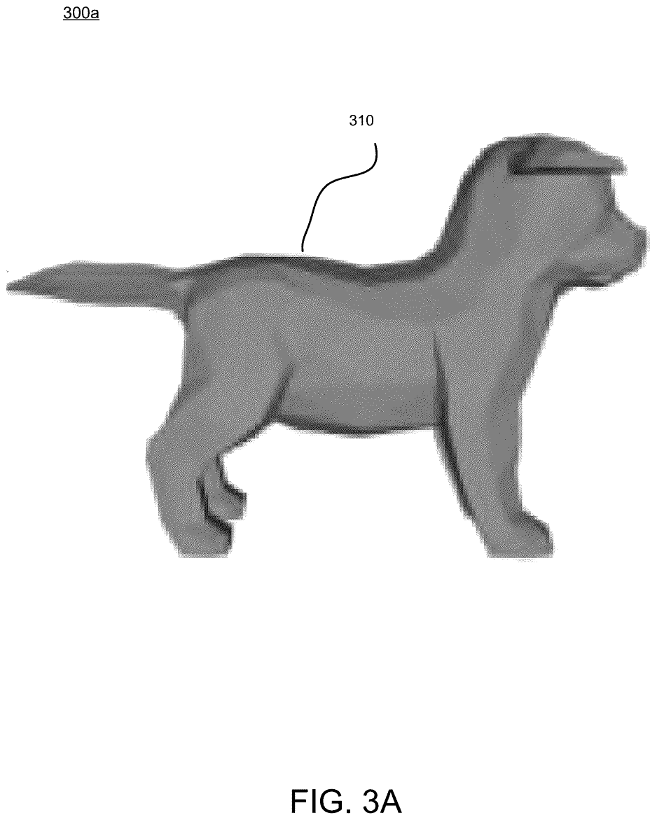

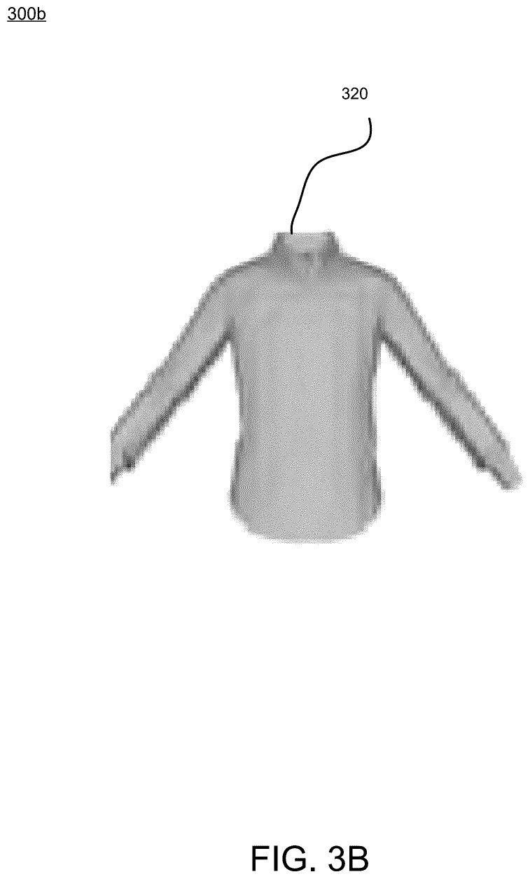

FIG. 3A is an illustration of a target avatar 310, in accordance with some implementations. For example, target avatar 310 is a dog avatar. It may be possible for target avatar 310 to wear a shirt, in the same/similar way that a humanoid avatar wears a shirt on its torso, with corresponding limbs protruding through sleeves.

It may be helpful to transform the vertices that originally define the garment (with respect to a humanoid avatar) to fit the garment to the target avatar 310 (such as dog avatar). As discussed, such transformation may involve piecewise deformation, so that a torso corresponds to one cluster, an upper arm corresponds to another cluster etc. These pieces may be deformed using affine matrices to affect a transformation, and stitched/fitted together at seams, such as when fitted onto target avatar 310.

FIG. 3B is an illustration of a possible garment 320, in accordance with some implementations. For example, FIG. 3B illustrates garment 320 as a long-sleeved shirt. The long-sleeved shirt may be divided into various clusters, such as a torso, arms (left and right, which may be subdivided further into upper arm and lower arm and hand, etc.). By dividing the shirt into such clusters, the clusters may be transformed to better fit a target avatar.

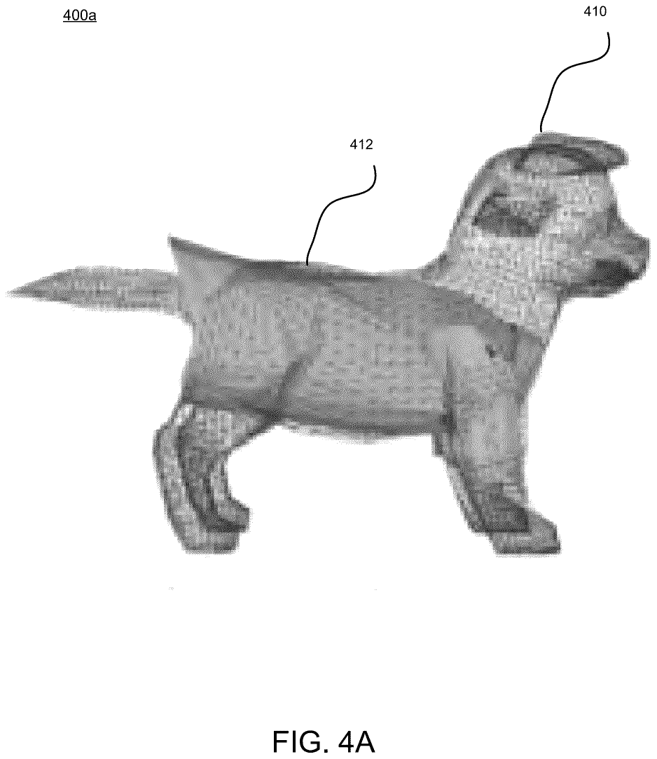

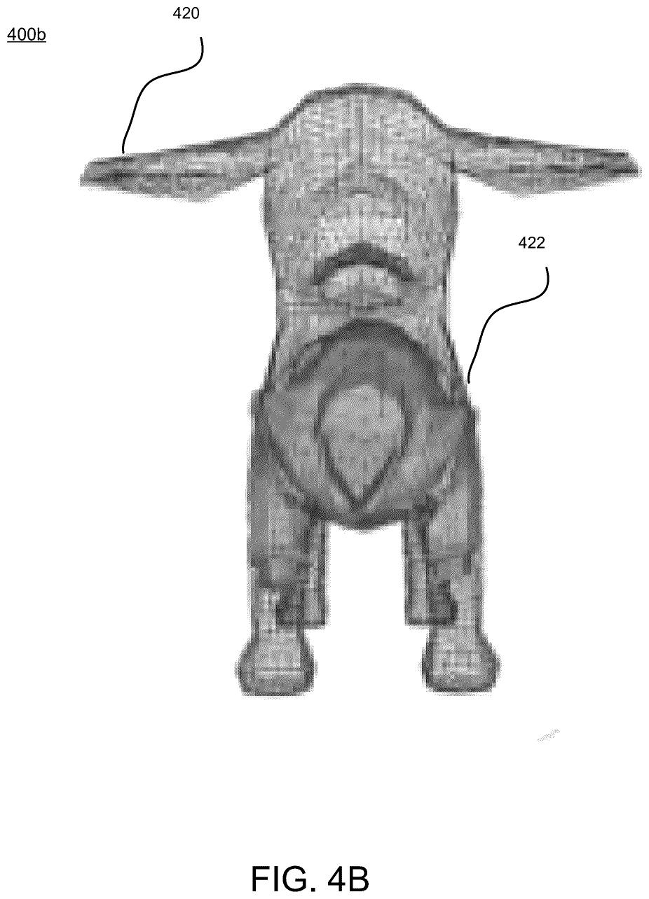

FIG. 4A is a side view 400a of a mesh corresponding to a target avatar 410, in accordance with some implementations. Here, the target avatar 410 is a dog avatar. FIG. 4A also illustrates a mesh of a shirt 412 that has been fitted onto target avatar 410 using various implementations discussed herein. The shirt 412 has been adapted to fit the shirt 412 onto a different morphology, in this case that of a dog avatar.

FIG. 4B is a rear view 400b of a mesh corresponding to the target avatar 420, in accordance with some implementations. Here, the target avatar 420 is a dog avatar, which could be the dog avatar of FIG. 4A. FIG. 4B also illustrates a mesh of a shirt 422 that has been fitted onto target avatar 420 using various implementations discussed herein. The shirt 422 (which could be the shirt 412 of FIG. 4A) has been adapted so to fit the shirt 422 onto a different morphology, in this case that of a dog avatar.

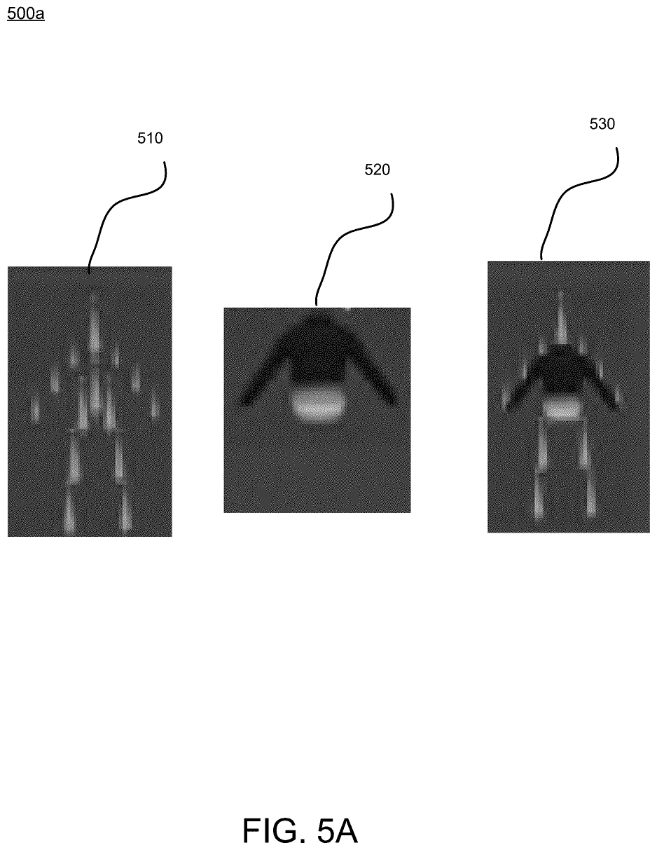

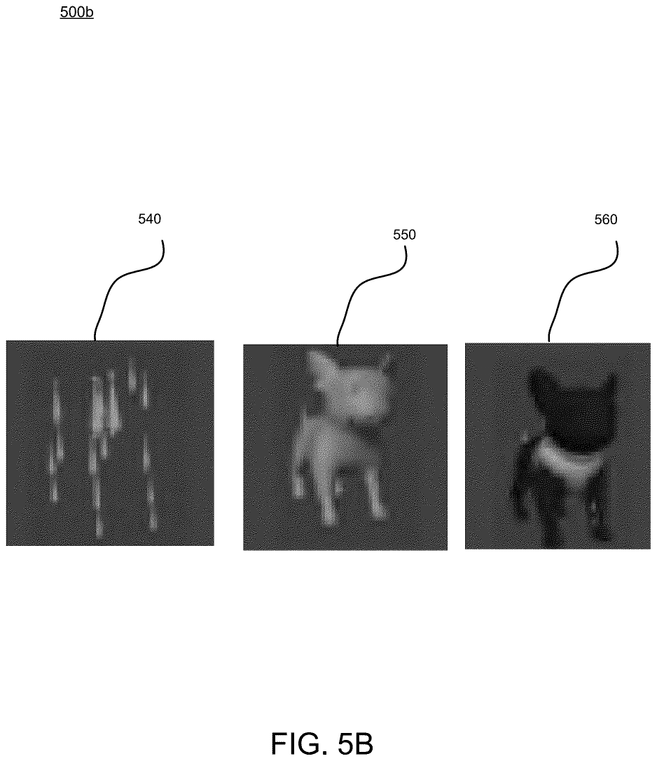

FIG. 5A is a view 500a of a skeletal structure and corresponding skinning weights for a garment for a human avatar, in accordance with some implementations. FIG. 5A illustrates a skeletal structure 510, where the skeletal structure 510 illustrates various bones included in a human avatar. FIG. 5A also illustrates skinning weights 520 for a garment, in this case a shirt. The skinning weights 520 are portrayed such that darker areas have lower skinning weights and are subjected to less influences with respect to bones in the skeletal structure 510.

FIG. 5A also illustrates a combination 530 of the skeletal structure 510 and the skinning weights 520, such that the combination 530 illustrates the skinning weights 520 overlaid onto the skeletal structure 510. Accordingly, the combination 530 illustrates the skinning weights 520. The skinning weights 520 indicate how the various bones in the skeletal structure of the associated avatar affect various vertices in the garment. The combination 530 is indicative of a humanoid avatar.

FIG. 5A illustrates, for example, based on the skinning weights 520 as overlaid onto the skeletal structure 510 in combination 530, that the garment has some influence on an upper torso and on arms of the skeletal structure 510. Combination 530 shows that the garment has a greater influence on a lower torso of the skeletal structure 510.

FIG. 5B is a view 500b of a skeletal structure and corresponding skinning weights for a garment for a dog avatar, in accordance with some implementations. FIG. 5B illustrates a skeletal structure 540, where the skeletal structure 540 illustrates various bones included in a dog avatar. FIG. 5B also illustrates skinning weights 550 for a garment, in this case a shirt. The skinning weights 550 are portrayed such that darker areas have lower skinning weights and are subjected to less influences with respect to bones in the skeletal structure 540.

FIG. 5B also illustrates a combination 560 of the skeletal structure 540 and the skinning weights 550, such that the combination 560 illustrates the garment overlaid onto the skeletal structure 540 illustrated. Accordingly, the combination 560 illustrates the skinning weights 550, which indicate how the various bones in the skeletal structure of the associated avatar affect various vertices in the garment. The combination 560 is indicative of a dog avatar having a shirt fitted onto it.

FIG. 5B illustrates, for example, based on the skinning weights 550 as overlaid onto the skeletal structure 540 in combination 560, that the garment has some influence on an upper torso and on arms of the skeletal structure 540. Combination 560 shows that the garment has a greater influence on a lower torso of the skeletal structure 540.

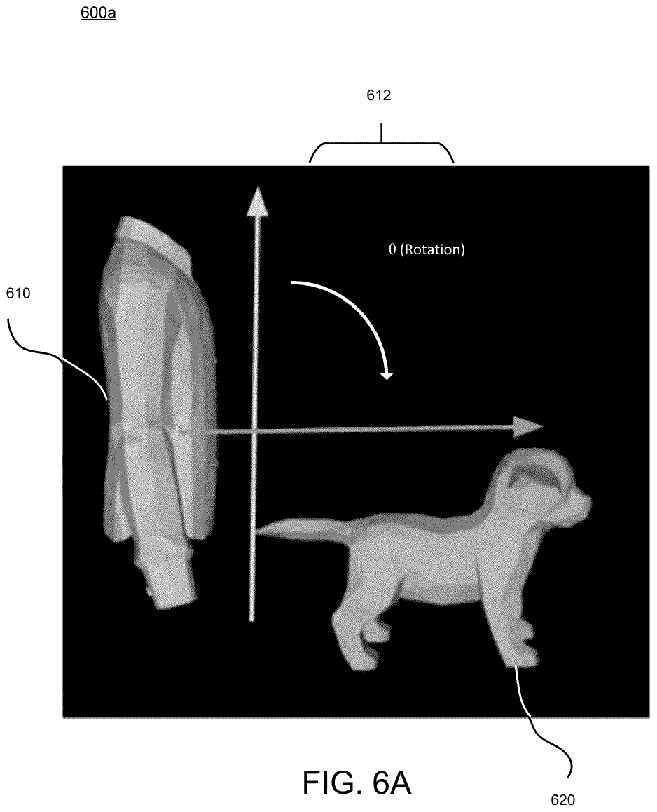

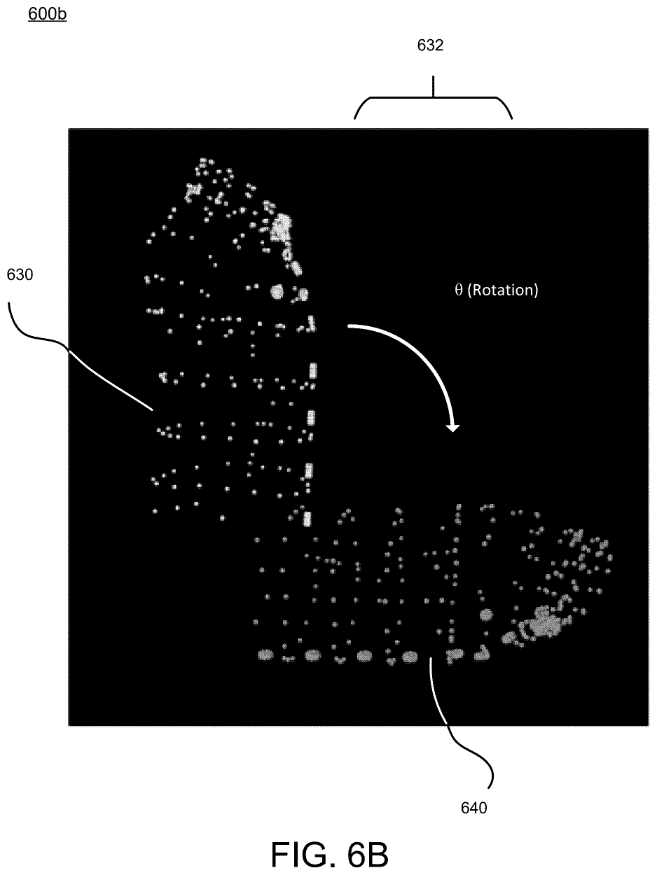

FIG. 6A is an illustration of initializing orientation of a garment with respect to a target avatar 600a, in accordance with some implementations. FIG. 6A illustrates a shirt 610 and a target avatar 620, where the shirt 610 is presented in a form that is designed to fit onto a humanoid avatar and the target avatar 620 is a dog avatar.

FIG. 6A illustrates that it is helpful to rotate the shirt 610 so that shirt 610 is properly aligned with target avatar 620. FIG. 6A illustrates that shirt 610 is subject to a rotation 612 (where the rotation may be provided as 0 degrees or radians). For example, shirt 610 is aligned vertically, such that a top of the shirt (that is, the neck of the shirt) is aligned vertically with respect to other portions of the shirt 610 (for example, the arms and the torso). Stated otherwise, the shirt 610 is originally aligned with the y-axis when the shirt 610 is originally adapted for fitting onto a humanoid avatar.

When the shirt 610 is fitted onto the target avatar 620, a rotation 612 is helpful. Specifically, the target avatar 620 illustrated in FIG. 6A is a dog avatar. The dog avatar, in comparison to a humanoid avatar, is aligned with the x-axis, such that the head of the dog avatar is in front of a portion of the dog avatar with its rear portion and tail. Likewise, the dog avatar has its limbs (front and rear legs and paws) situated underneath its torso.

Hence, to transform the shirt 610 so that the shirt 610 can be successfully fitted onto the dog avatar, the shirt 610 is subjected to a rotation 612 of 90°. Part of the rotation 612 includes aligning the shirt 610 and the dog avatar so that the front of the shirt 610 corresponds to a front of the dog avatar.

Such alignment by rotation 612 is helpful because for a proper fit of the shirt 610 onto the dog avatar to occur, the front of the shirt 610, which corresponds to a front portion of the humanoid avatar, is to correspond to a front of the dog avatar, such that the front of the shirt 610, which may correspond to a chest of a humanoid avatar instead of a back of the humanoid avatar, corresponds to a front of the dog avatar, which is the abdomen of the dog avatar, rather than a back of the dog avatar. Hence, without this rotation 612, the front of the shirt may be oriented to the back of the dog avatar.

FIG. 6B is an illustration of initializing orientation of vertices of a garment with respect to vertices of a target avatar 600b, in accordance with some implementations. FIG. 6B illustrates a similar concept to that of FIG. 6A, but illustrates vertices involved in a rotation 632.

For example, vertices 630 are vertices in a cluster of a shirt. These vertices 630 are subjected to a rotation 632 of 90°. Such a rotation 632 aligns vertices in a manner similar to that of FIG. 6A. After such a rotation 632, vertices 630 that are included in a cluster of vertices 630 for a torso of a shirt adapted to a humanoid avatar become vertices 640 that are included in a cluster of vertices 640 for a torso of a shirt adapted to a dog avatar.

FIG. 7A is an illustration of an initial iteration 700a of fitting vertices of a target avatar and corresponding vertices of a garment vertex cluster, in accordance with some implementations. The vertex fitting includes taking vertices of a dog avatar 710 and taking vertices of the torso of a shirt 712 and iteratively optimizing the vertices of the torso of the shirt 712 to fit onto a torso of the dog avatar 710.

While vertices of the dog avatar 710 illustrate all of the vertices of the dog avatar 710, parts of the garment are fitted to the vertices of the dog avatar 710 a subset at a time. For example, vertices of the garment vertex cluster 712 (for example, a torso) are fitted based on corresponding points of the torso of the vertices of the dog avatar 710. For example, various implementations may match torso points to torso points, as including points in other clusters may decrease the quality of the fit.

In FIG. 7A, the vertices of the torso of the shirt 712 are still far away from the corresponding vertices of the dog avatar 710. To cause the corresponding vertices to better match one another, a chamfer loss is measured as a first loss function and used to optimize/improve the fit. Such optimizing/improving includes aligning points on the shirt with points on the dog by performing rotations, scales, and shear transformations. The alignment may also include finding any appropriate translations.

The alignment is measured based on a chamfer loss. Such a chamfer loss may be calculated using Equation 1:

$${ℒ}_{chamfer} ( P , Q ) = \frac{{\sum }_{p ∈ P} {min}_{q ∈ Q} {‖ p - q ‖}_{2}^{2}}{\vert P \vert} + \frac{{\sum }_{q ∈ Q} {min}_{p ∈ P} {‖ q - p ‖}_{2}^{2}}{\vert Q \vert} . \qquad ( Equation 1 )$$

Chamfer loss should be normalized based on the number of points.

The chamfer loss may be adapted to be differentiable, which permits minimization (min) techniques such as gradient descent to be used, given that a min function (without modification) is not suitably differentiable, and a differentiable approximation of the min function is used (for gradient descent). For example, the nearest-neighbor search may be performed using optimized kernels.

The output of this search is a set of indications corresponding to minimum/reduced distances. With the nearest neighbor indices identified, the gradient of the loss with respect to the network's output can be calculated via the chain rule. The gradient of the min operation becomes the gradient of the squared Euclidean distance with respect to the closest point's coordinates, which is computed from the coordinates.

FIG. 7B is an illustration of an early iteration 700b of fitting vertices of a target avatar and corresponding vertices of a garment vertex cluster, in accordance with some implementations. FIG. 7B illustrates that there has been initial iteration(s) of minimizing/reducing the chamfer loss. Accordingly, the vertices of the dog avatar 720 remain in a similar position (given that the other vertices are transformed to better fit the vertices of the dog avatar 720).

The vertices of the torso of the shirt 722 have been transformed to better fit a corresponding portion of the vertices of the dog avatar 720. Such transformation may include rotation, scale, and shear transformations (and possibly translations).

These transformations cause the vertices of the shirt 722 to better fit the vertices of the dog avatar 720. The transformations correspond to affine transformations resulting from applying the optimization matrices to map vertices in garment vertex clusters to vertices in target avatar vertex clusters and improve the fit of the shirt 722 onto the dog avatar 720 as the chamfer loss is optimized.

FIG. 7C is an illustration of a later iteration 700c of fitting vertices of a target avatar and corresponding vertices of a garment vertex cluster, in accordance with some implementations. FIG. 7C illustrates that there have been several initial iterations of minimizing/reducing the chamfer loss. Accordingly, the vertices of the dog avatar 730 remain in a similar position (given that the other vertices are transformed to better fit the vertices of the dog avatar 720).

The vertices of the torso of the shirt 732 have been transformed to better fit a corresponding portion of the vertices of the dog avatar 730. Such transformation may include rotation, scale, and shear transformations (and possibly translations).

These transformations cause the vertices of the shirt 732 to better fit the vertices of the dog avatar 730. The transformations correspond to affine transformations resulting from applying the optimization matrices to map vertices in garment vertex clusters to vertices in target avatar vertex clusters and improve the fit of the shirt 732 onto the dog avatar 730 as the chamfer loss is optimized. The fit is better, given a larger number of iterations.

FIG. 7D is an illustration of a final iteration 700d of fitting vertices of a target avatar and corresponding vertices of a garment vertex cluster, in accordance with some implementations. FIG. 7D illustrates that there has been an initial iteration of minimizing/reducing the chamfer loss. Accordingly, the vertices of the dog avatar 740 remain in a similar position. The vertices of the torso of the shirt 742 have been transformed to better fit a corresponding portion of the vertices of the dog avatar 740. Such transformation may include rotation, scale, and shear transformations (and possibly translations).

These transformations cause the vertices of the shirt 742 to better fit the vertices of the dog avatar 740. At FIG. 7D, the loss functions have fully optimized/completed the fit. The fit may be deemed complete based on one of two reasons. First, the fit may satisfy a first loss function (a chamfer loss function), a second loss function (point-to-point loss function, based on an L1 norm), or a combination of these loss functions. Second, the fitting may be stopped for another reason (a limit on computational resources, progress has slowed, etc.). It may be observed from FIG. 7D that, after the optimization/fitting is complete, the vertices of the shirt 742 have a good fit onto corresponding vertices of the dog avatar 740.

FIG. 8 is a flowchart illustrating aspects of a method 800 to fit a garment onto a target avatar, in accordance with some implementations. Method 800 may begin at block 802.

At block 802, garment information is obtained. For example, the garment information may include a plurality of garment vertices, a respective garment skinning weight for each vertex of the plurality of garment vertices, and a skeletal structure of an avatar associated with the garment that defines source bones for the garment. Block 802 may be followed by block 804.

At block 804, target avatar information is obtained. For example, the target avatar information may include a plurality of target avatar vertices, a respective target avatar skinning weight for each vertex of the plurality of target avatar vertices, and a skeletal structure of the garment that defines target bones of the target avatar. Block 804 may be followed by block 806.

While FIG. 8 shows receipt of garment information prior to target avatar information, this approach is not limiting and the sequence may be reversed or the garment information and the target avatar information may be received in parallel.

At block 806, garment vertices are grouped. For example, the plurality of garment vertices are grouped into a plurality of garment vertex clusters corresponding to the source bones, based on the garment vertex skinning weights. At a high level, the grouping includes initializing a garment vertex cluster for each bone in a corresponding skeletal structure of an avatar associated with the garment, followed by processing each garment vertex such that each garment vertex is considered with respect to each source bone associated with the garment.

If, for a given bone, a corresponding vertex in the garment has a skinning weight greater than 0, that vertex is added to a corresponding cluster for that portion of the garment. Additional details of the grouping of the garment vertices are presented with respect to FIG. 12A. Block 806 may be followed by block 808.

At block 808, target avatar vertices are grouped. For example, the plurality of target avatar vertices are grouped into a plurality of target avatar vertex clusters corresponding to the target bones, based on the target avatar vertex skinning weights. At a high level, the grouping includes initializing a target avatar vertex cluster for each bone in a corresponding skeletal structure of the target avatar, followed by processing each target avatar vertex such that each target avatar vertex is considered with respect to each target bone in the target avatar.

If, for a given target bone, a corresponding vertex in the target avatar has a skinning weight greater than 0, that vertex is added to a corresponding cluster for that portion of the target avatar. Additional details of the grouping of the target avatar vertices are presented with respect to FIG. 12B. Block 808 may be followed by block 810.

While FIG. 8 shows grouping garment vertices prior to target avatar vertices, this approach is not limiting and the sequence may be reversed or the garment information and the target avatar information may be grouped in parallel.

At block 810, optimization matrices are initialized. For example, the optimization matrices may be initialized based on the source bones of an avatar associated with the garment and the target bones of the target avatar, where the optimization matrices define transformations that include pose rotations that cause vertices in garment vertex clusters to map to corresponding vertices in corresponding target avatar vertex clusters. The transformations may be affine transformations.

There may be N affine matrices for N different bone parts, each matrix referred to as MB_i. For each bone (b_i) in skeletal bones, the corresponding affine matrix is initialized as a 4×4 matrix including all zeros. There may be M affine matrices for N different seam parts, referred to as MS_i. For each seam part (s_i) in a set of seam parts, the corresponding affine matrix is initialized as a 4×4 matrix including all zeros. These matrices are subsequently computed by minimizing the squared L2 differences between sets of points with one to correspondences.

For example, let {p₀, p₁, . . . , pₙ} be a set of points on a garment. Here, pᵢ ∈ [symbol] ³ denotes the ith point position in three dimensions. Also, qᵢ∈ [symbol] ³ denotes the closest point of pᵢ on a bone (or seam) part. Computing the 4-by-4 transformation matrix T∈ [symbol] ^{4×4} from {pᵢ} to {qᵢ} amounts to minimizing the following objective function E:

$${min}_{T} E ( T ) = {\sum }_{i}^{n} {‖ [ \begin{matrix}{q}_{i} \\ 1\end{matrix} ] - T [ \begin{matrix}{p}_{i} \\ 1\end{matrix} ] ‖}^{2}$$

This is an unconstrained quadratic optimization problem. By setting the derivative to zero ∂E/∂T=0 it may be possible to obtain the optimal transformation T with a numerical solver for a system of linear equations.

Block 810 may be followed by block 812.

At block 812, the optimization matrices are updated. Such updating may occur after the optimization matrices are initialized, such as at block 810. The optimization matrices may be updated based on a first loss function calculated from aligning vertices in garment vertex clusters with corresponding vertices in target avatar vertex clusters, based on a second loss function calculated from regularization based on centroids of bones associated with the garment vertex clusters and centroids of corresponding bones of the target avatar vertex clusters, or a combination of these loss functions.

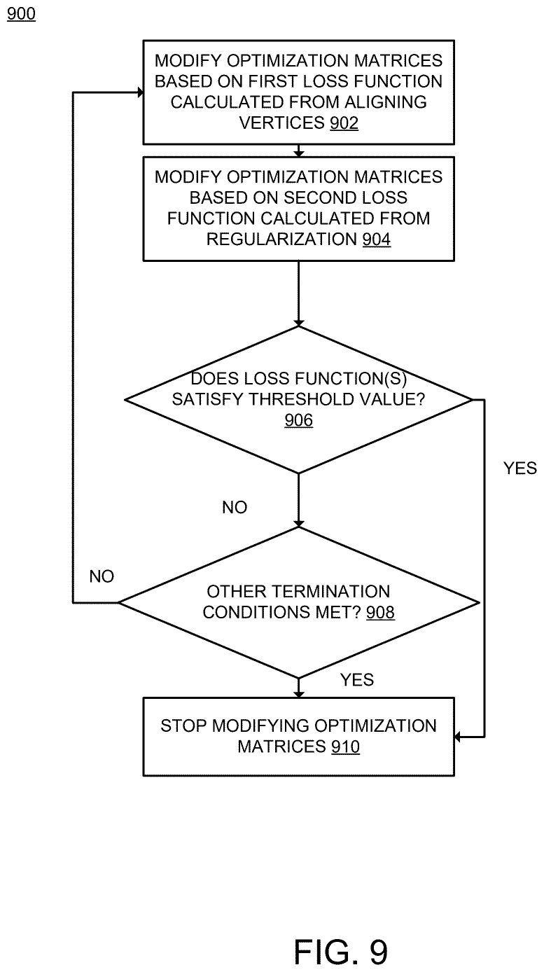

The optimization matrices are updated so as to transform points from the garment into corresponding points of the target avatar, achieving the best possible fit based on the above loss functions. Greater details of such updating are presented in the discussion of FIG. 9. Block 812 may be followed by block 814.

At block 814, the garment is fitted onto the target avatar using the optimization matrices as affine transformations. The 4×4 optimization matrices represent 3D affine transformations by combining linear transformations (rotation, scaling, shear) in the upper-left 3×3 submatrix and translation in the last column, using homogeneous coordinates (a point represented with a “1” in the fourth component) to provide for both.

Multiplying a point's homogeneous coordinate vector by this 4×4 matrix performs the combined linear and translational operations in a single step, transforming points to new locations. The upper-left 3×3 submatrix (A) is a part that handles linear transformations like rotation, scaling, and shearing. The last column has the first three elements of the last column form the translation vector, shifting the object in space. The last row in the matrix is [0, 0, 0, 1] to keep points on the w=1 plane after the transformation. Block 814 may be followed by block 816.

At block 816, the target avatar may be displayed using the fitted garment. The garment has been fitted onto the target avatar, as discussed above. The fitting includes optimizing/improving the loss functions or other metrics that determine how many fitting iterations to perform. Hence, when displaying the target avatar, the target avatar is displayed such that the garment is fitted onto it, as discussed above. Accordingly, the target avatar is displayed, wherein the target avatar is depicted as wearing the garment.

For example, if the garment is a shirt, the shirt may cover limbs and a torso of the target as appropriate. For such a shirt, the shirt may have originally been constructed for fitting onto a humanoid avatar, and fit onto a dog avatar, such that the torso of the shirt is adapted to the torso of the dog avatar and the limbs of the shirt are adapted to reflect that the shirt's arms are to correspond to the limbs of the dog avatar.

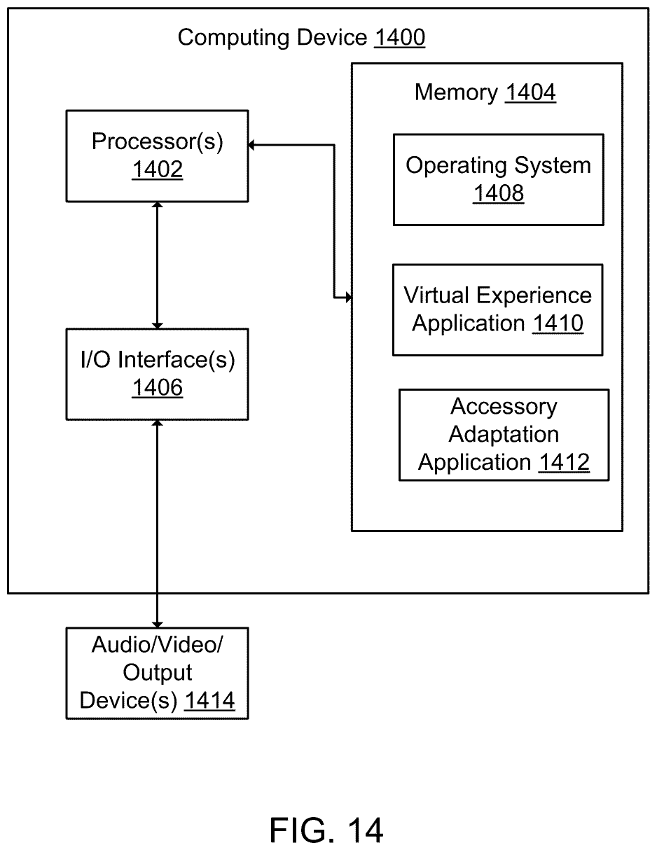

While FIG. 8 illustrates several operations provided in a certain order for carrying out method 800, it may be noted that there may be a variety of modifications to method 800 and/or to any of the other methods described herein. For example, other operations may be added, operations may be omitted, operations may be modified, operations may be combined, operations may be supplemented with other operations, operations may be replaced by other operations, or the order of operations may be varied. For example, the sequence of certain operations may be changed, or some of the operations may be carried out in parallel, as appropriate. Various operations as illustrated in method 800 and/or any other method described herein may be implemented by various hardware and/or software. For example, FIG. 1 and FIG. 14 illustrate various components (such as one or both of the virtual experience application 112 and the virtual experience engine 104) that may implement the various operations provided in method 800 and/or in any other method described herein, such as by being programmed using various appropriate software to configure the hardware to perform method 800 and/or any other method described herein.

FIG. 9 is a flowchart illustrating aspects of a method 900 to modify optimization matrices to improve a fit between a garment and a target avatar, in accordance with some implementations. Method 900 may begin at block 902.

At block 902, the optimization matrices are modified based on a first loss function calculated from aligning vertices between the garment and the target avatar. For example, the first loss function may be a chamfer loss function. Such a chamfer loss function is calculated as a sum of squared Euclidean distances from vertices in the garment vertex clusters to corresponding nearest neighbors in the target avatar vertex clusters and squared Euclidean distances from vertices in the target avatar vertex clusters to corresponding nearest neighbors in the garment vertex clusters.

For example, the first loss function may be a chamfer loss function calculated using Equation 1 as follows.

$${ℒ}_{chamfer} ( P , Q ) = \frac{{\sum }_{p ∈ P} {min}_{q ∈ Q} {‖ p - q ‖}_{2}^{2}}{\vert P \vert} + \frac{{\sum }_{q ∈ Q} {min}_{p ∈ P} {‖ q - p ‖}_{2}^{2}}{\vert Q \vert} . \qquad ( Equation 1 )$$

Block 902 may be followed by block 904.

At block 904, the optimization matrices are further modified based on a second loss function (L1 norm) calculated from regularization, calculated using Equation 2 and Equation 3 as follows.

$${ℒ}_{L 1} ( P , Q ) = \frac{1}{n} {\sum }_{i = 1}^{n} {‖ {p}_{i} - {q}_{i} ‖}_{1} . \qquad ( Equation 2 )$$

$${‖ {p}_{i} - {q}_{i} ‖}_{1} = {\sum }_{j = 1}^{d} \vert {p}_{i}^{j} - {q}_{i}^{j} \vert . \qquad ( Equation 3 )$$

Hence, in some implementations, Total Loss= [symbol] _{chamfer}(P, Q)+ [symbol] _{L1}(P, Q). In some implementations, the total loss (the sum of the chamfer loss and the L1 norm) provides a metric of the overall quality of the fit. Block 904 may be followed by block 906.

Block 902 and block 904 are presented in an order such that the chamfer loss at block 902 is followed by the point-to-point loss at block 904. The loss function calculations may be performed in another order or in parallel. Additionally, in other implementations, only one loss function may be used, or other loss functions or modified loss functions may be used. For example, the chamfer loss function may be normalized in situations where the number of points in the respective point clouds differ from one another.

At block 906, it is determined if the loss function(s) satisfy a threshold value. If so (the threshold values are satisfied), block 906 is followed by block 910. If not, (the threshold values are not satisfied), block 906 is followed by block 908. For example, it may be confirmed that the first loss function (which may be a chamfer loss, as discussed above) is less than a given value, or the second loss function (which may be a point-to-point loss function, as discussed above) is less than a given value, or the total loss function (which may be a sum of a first loss function that is a chamfer loss and a second loss function that is a point-to-point loss function, as discussed above).

In some implementations, the sum of the two loss functions weighs each loss function evenly, and a simple sum of the two loss functions is used as the overall loss function to be minimized. In other implementations, the total loss function is based on weighting the first loss function and the second loss function. In some implementations, the total loss function is based on the first loss function or the second loss function.

At block 908, it is determined if other termination conditions are met. For example, the other termination conditions may include updating until a computational budget for updating is exhausted (such as a number of iterations or another amount of computational resources have been consumed), or until a change in values of the optimization matrices between consecutive iterations falls below a threshold, or a combination thereof.

If so (there is at least one other termination condition that is met), block 908 is followed by block 910. If not (no other termination condition is met), block 908 is followed by block 902. That is, if block 906 and block 908 both indicate that there is no reason to keep modifying the optimization matrices, method 900 may conclude.

These termination tests are based on the concept that the modifying may conclude once one or both loss function values satisfy a condition, or if another condition indicates that further iterations are not of value. While FIG. 9 illustrates block 906 as occurring before block 908, this order may be reversed (other termination conditions are tested for first) or these tests may be performed in parallel (for example, termination may occur based on a combination of loss function values and other considerations).

At block 910, modifying the optimization matrices stops and the optimization matrices are applied as affine transformations, as in block 814. As discussed above, the modifying may stop once the matrices meet a quality metric and/or once further modifying is not productive or involves too many resources. Once the optimization matrices have been fully updated, the optimization matrices may be applied for use in fitting the garment onto the avatar, where the avatar may be subsequently displayed as wearing the garment.

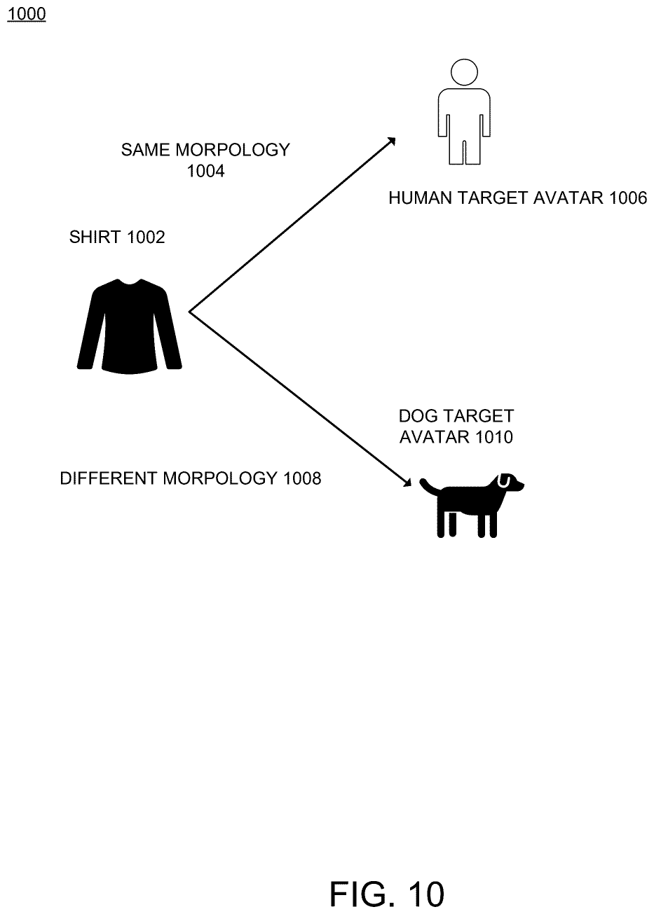

FIG. 10 is a diagram 1000 illustrating aspects of examples of morphology for a garment, a first target avatar, and a second target avatar, in accordance with some implementations. Diagram 1000 may begin at a shirt 1002. As illustrated, shirt 1002 is fitted for a humanoid morphology. The shirt 1002 may be fitted based on a same morphology 1004 or a different morphology 1008.

Here, a morphology may refer to an underlying mesh and a skeletal structure, whether the morphology is for an accessory (for example, a garment, such as a shirt 1002) or for an avatar. FIG. 10 illustrates that a shirt 1002 may be fitted with a same morphology 1004 onto a human target avatar 1006. Such fitting involves minimal/reduced adaptation. While human target avatar 1006 may dictate some adjustment to fit the shirt 1002 onto the human target avatar 1006, the overall form of shirt 1002 can stay the same.

Alternatively, shirt 1002 may be fitted onto a different morphology 1008, such as a dog target avatar 1010. One of the advantages provided by various implementations is that while it is relatively easy to fit shirt 1002 onto a human target avatar 1006 given that there is a same morphology 1004, it may be difficult to fit shirt 1002 onto a dog target avatar 1010, given that the dog target avatar 1010 has a different morphology and shirt 1002 is deformed and/or modified for a fit with a reasonable loss function value to be available.

It is possible using some implementations as discussed herein to establish correspondences between bones of the shirt's morphology and bones of the dog's morphology. Such correspondences provide for a transformation of the shirt 1002. Even though the morphology is initially different and it may be difficult to fit the shirt 1002 onto the dog target avatar 1010, the loss functions can be optimized to adapt the shirt 1002 morphology onto the dog target avatar 1010. After the fitting, the shirt 1002 fits onto the dog target avatar 1010 well (given that the optimized transformation maps points vertices of the shirt 1002 onto vertices of the dog target avatar 1010 with good results).

There may also be various other implementations that provide for the fitting of a garment to an avatar that has a different skeletal structure or duplication of semantic labels of bones. Such other implementations may involve an assumption that a source bone semantic label has a correspondence in the target avatar bone semantic label. In these implementations, similar to other implementations, the target vertices are split into different clusters based on the correspondence/influence of each source bone.

Instead of 1:1 fitting from a source bone to a target bone, the alternative process may involve a 1:K fitting, where K is a number of duplicate semantic labeling of bones (for example, a left lower arm of a shirt originally adapted for a humanoid avatar may correspond to 2 left lower arms in a dog avatar, such that K is 2, and a left lower arm of a shirt originally adapted for a humanoid avatar may correspond to 4 left lower arms in an octopus avatar, such that K is 4.

Various implementations may provide ways that fit the garment using such duplication and/or other appropriate modification. For example, various implementations may provide techniques that define how and where to poke holes onto and/or through the garment to better fit the garment onto a given target avatar.

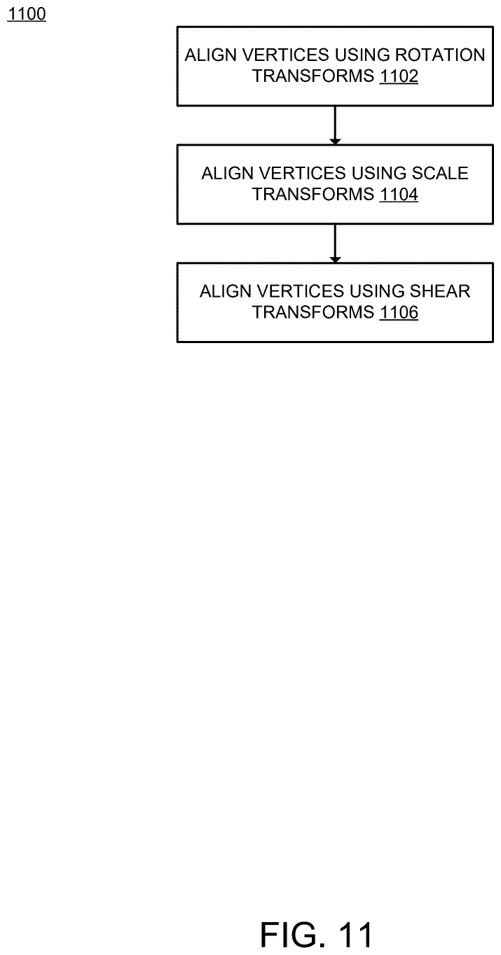

FIG. 11 is a flowchart illustrating aspects of a method 1100 to align vertices in the garment with vertices in the target avatar, in accordance with some implementations. Method 1100 may begin at block 1102.

At block 1102, the vertices are aligned using rotation transforms. For example, as discussed above, the linear transformation of the affine transformation may include a rotation transformation. Such a rotation transformation may include an affine transformation matrix. An example rotation matrix is Matrix 1, below, having the values (for example, around the Z-axis, where θ is the angle of rotation):

$$Matrix 1 : \begin{matrix}cos ( θ ) & - sin ( θ ) & 0 & 0 \\ sin ( θ ) & cos ( θ ) & 0 & 0 \\ 0 & 0 & 1 & 0 \\ 0 & 0 & 1 & 1\end{matrix} .$$

A 3D rotation occurs around an axis, not a single point. For rotation around the cardinal axes (X,Y, Z), the transformation matrices are 4×4 and incorporate the sine and cosine of the rotation angle θ. Block 1102 may be followed by block 1104.

At block 1104, the vertices are aligned using scale transforms. Such a rotation transformation may include an affine transformation matrix. An example scale matrix is Matrix 2, below, having the values (for scaling in the X, Y, and Z dimensions, where Sx, Sy, and Sz are the scaling factors for each axis).

$$Matrix 2 : \begin{matrix}Sx & 0 & 0 & 0 \\ 0 & Sy & 0 & 0 \\ 0 & 0 & Sz & 0 \\ 0 & 0 & 0 & 1\end{matrix} .$$

Block 1104 may be followed by block 1106.

At block 1106, the vertices are aligned using shear transforms. Such a shear transformation may include an affine transformation matrix. An example shear matrix is Matrix 3, below, having the values (for example, for a shear parallel to the Z-axis, where Sx and Sy determine the amount of shear in the X and Y directions, respectively, based on the position along the Z-axis).

$$Matrix 3 : \begin{matrix}1 & 0 & Sx & 0 \\ 0 & 1 & Sy & 0 \\ 0 & 0 & 1 & 0 \\ 0 & 0 & 0 & 1\end{matrix} .$$

A shear transformation skews the object, making the skewed object appear distorted. A shear matrix shifts points in one direction, proportional to the position of the points along another axis.

These individual transformation matrices can be combined by multiplying the matrices in a selected order to create a single composite matrix. This combining of transformation matrices permits efficient application of multiple transformations to an object. While FIG. 11 characterizes the order of block 1102 (rotation), 1104 (scale) and 1106 (shear) as occurring in that order, other orders are possible.

It may be recognized that applying different transformations in a different order may have a different overall effect. Also, an affine matrix can apply a translation. While a translation is not a linear transformation, fitting the garment vertices onto the target avatar may include providing an appropriate translation as part of the fitting processing using the affine optimization matrices to situate the garment and the target avatar at places in space that leads to an optimized fit.

FIG. 12A is a flowchart illustrating aspects of a method 1200a to group vertices in a garment to correspond to bones in a skeletal structure of a corresponding avatar, in accordance with some implementations. Method 1200a may begin at block 1202. In FIG. 12A, method 1200a refers to “garment bones” and “garment bone clusters” for ease of explanation. The term “garment bones” is used herein to refer to bones present in an avatar corresponding to a garment in its original form, and “garment bone clusters” is used herein to refer to clusters of vertices grouped in conjunction with such “garment bones.” When “bones” are referred to as being “in” a given garment, this indicates that the bone in question corresponds to a bone present in an associated avatar corresponding to the garment.

At block 1202, garment bone clusters are initialized for each garment bone. For example, each garment bone has a corresponding cluster. When a given garment bone cluster is initialized, the garment bone cluster is initialized such that the cluster does not initially include any of the vertices of the garment. The given garment bone cluster includes an appropriate data structure that permits the cluster to store a group of vertices, such as a list of lists. Block 1202 may be followed by block 1204.

At block 1204, the next vertex in the garment is selected. For example, there may be a mechanism to methodically iterate through each vertex in the garment until every vertex in the garment has been grouped as appropriate. Such a mechanism may traverse a representation of the vertices in the garment (such as a graph) in a way that each iteration iterates to a garment vertex that has not yet been processed and ensures that every vertex in the garment has been processed before stopping. This approach may be helpful to enable the vertices in the garment to be processed efficiently without omitting any vertices from garment clusters in which the vertices are to be included. Block 1204 may be followed by block 1206.

At block 1206, the next bone in the garment is selected. For example, there may be a mechanism to methodically iterate through each bone in the garment so that, for each vertex, it is determined whether that bone includes a vertex in a corresponding cluster. Such a mechanism may traverse a representation of the bones in a garment (such as a graph) in a way that each iteration iterates to a bone that has not yet been processed and ensures that every bone in the garment has been processed before stopping.

This approach may be helpful to enable the bones in the garment to be processed efficiently without omitting any vertices from garment clusters in which the vertices are to be included. It may be noted that block 1206 follows block 1204 in a way such that the vertices are processed individually, and the vertices are considered for each bone to group the vertices into corresponding bones. In some implementations, it may be possible to do the opposite and iterate through each of the bones, and test each vertex to see which cluster the vertex belongs in. Block 1206 may be followed by block 1208.

At block 1208, it is determined if a skinning weight of a current vertex with respect to a current garment bone is greater than zero. If so, this indicates that the current bone has an influence on the current vertex, indicating that the current vertex is included in a cluster corresponding to a current bone. In this case, block 1208 is followed by block 1210. If not, the current vertex is not included in a cluster corresponding to a current bone (given that there is no reason to incorporate the current vertex in the current cluster, and doing so may actually interfere with the proper construction of the current cluster). In this case (the vector is not included), block 1208 is followed by block 1212 to determine if additional bones exist.

At block 1210, the current vertex is added to the current garment vertex cluster. For example, if the current garment is a shirt, the current garment vertex cluster is a torso of the shirt, and the current vertex is a vertex located on the chest of the shirt, the current vertex may be added to the cluster of vertices in the torso. Block 1210 may be followed by block 1212 to determine if additional bones exist for consideration with respect to the current vertex.

At block 1212, it is determined whether there is another garment bone that is to be tested to see if the current vertex being processed belongs in another cluster. If so (there is an additional garment bone), block 1212 is followed by block 1206, such that the next garment bone may be considered with respect to grouping the current vertex into corresponding clusters. If not, block 1212 has established that all of the garment bones have been considered for the current vertex, and block 1212 is followed by block 1214.

At block 1214, it is determined whether there is another vertex that is to be tested to determine which vertex groups the vertex belongs in. If so, block 1214 is followed by block 1204, such that the next vertex may be considered with respect to grouping the next vertex with respect to corresponding bones. If not (there are no more vertices) block 1214 is followed by block 1216. As noted, block 1212 and block 1214 may be reversed, such that the bone clusters are considered first, such that each cluster is associated with vertices before additional bones are considered.

At block 1216, there are no more garment vertices, and each garment vertex has been considered with respect to each garment bone for the purpose of grouping. An alternative stopping condition may be if there are no more garment bones, and each garment bone has been considered with respect to each garment vertex for the purpose of grouping. Hence, at block 1216, method 1200a stops.

FIG. 12B is a flowchart illustrating aspects of a method 1200b to group vertices in a target avatar to correspond to bones in a skeletal structure, in accordance with some implementations. Method 1200b may begin at block 1220.

At block 1220, target avatar bone clusters are initialized for each target avatar bone. For example, each target avatar bone has a corresponding cluster. When a given target avatar bone cluster is initialized, the target avatar bone cluster is initialized such that the cluster does not initially include any of the vertices of the target avatar. The given target avatar bone cluster includes an appropriate data structure that permits the cluster to store a group of vertices. Block 1220 may be followed by block 1222.

At block 1222, the next vertex in the target avatar is selected. For example, there may be a mechanism to methodically iterate through each vertex in the target avatar until every vertex in the target avatar has been grouped as appropriate. Such a mechanism may traverse a representation of the vertices in the target avatar (such as a graph) in a way that each iteration iterates to a target avatar vertex that has not yet been processed and enables every vertex in the target avatar to be processed before stopping. This approach may be helpful to enable the vertices in the target avatar to be processed efficiently without omitting any vertices from target avatar clusters in which the vertex are to be included. Block 1222 may be followed by block 1224.

At block 1224, the next bone in the target avatar is selected. For example, there may be a mechanism to methodically iterate through each bone in the target avatar so that, for each vertex, it is determined whether that bone includes a vertex in a corresponding cluster. Such a mechanism may traverse a representation of the bones in a target avatar (such as a graph) in a way that each iteration iterates to a bone that has not yet been processed and enables every bone in the target avatar to be processed before stopping.

This approach may be helpful to enable the bones in the target avatar to be processed efficiently without omitting any vertices from target avatar clusters in which the vertices are to be included. It may be noted that block 1224 follows block 1222 in a way such that the vertices are processed individually, and the vertices are considered for each bone to group the vertices into corresponding bones. In some implementations, it may be possible to do the opposite and iterate through each of the bones, and test each vertex to see which cluster the vertex belongs in. Block 1224 may be followed by block 1226.

At block 1226, it is determined if a skinning weight of a current vertex with respect to a current target avatar bone is greater than zero. If so, this indicates that the current bone has an influence on the current vertex, indicating that the current vertex is to be included in a cluster corresponding to a current bone. In this case, block 1226 is followed by block 1228. If not, the current vertex is not included in a cluster corresponding to a current bone (given that there is no reason to incorporate the current vertex in the current cluster, and doing so may actually interfere with the proper construction of the current cluster). In this case (the vector is not included), block 1226 is followed by block 1230 to determine if additional bones exist.

At block 1228, the current vertex is added to the current target avatar vertex cluster. For example, if the current target avatar is a dog avatar, the current target avatar vertex cluster is a torso of the dog avatar, and the current vertex is a vertex located on the chest of the dog avatar, the current vertex may be added to the cluster of vertices in the torso of the dog avatar. Block 1228 may be followed by block 1230 to determine if additional bones exist for consideration with respect to the current vertex.

At block 1230, it is determined whether there is another target avatar bone that may be tested to see if the current vertex being processed belongs in another cluster. If so (there is an additional target avatar bone), block 1230 is followed by block 1224, such that the next target avatar bone may be considered with respect to grouping the current vertex into corresponding clusters. If not, block 1230 has established that all of the target avatar bones have been considered for the current vertex, and block 1230 is followed by block 1232.

At block 1232, it is determined whether there is another vertex that may be tested to determine which vertex groups the vertex belongs in. If so, block 1232 is followed by block 1222, such that the next vertex may be considered with respect to grouping the next vertex with respect to corresponding bones. If not (there are no more vertices) block 1232 is followed by block 1234. As noted, block 1230 and block 1232 may be reversed, such that bone clusters are considered first, such that each cluster is associated with vertices before additional bones are considered.

At block 1234, there are no more target avatar vertices, and each target avatar vertex has been considered with respect to each target avatar bone for the purpose of grouping. Hence, at block 1234, method 1200b stops.

FIG. 13 is a flowchart illustrating aspects of a method 1300 to improve a fit of the garment onto the target avatar based on controlling strain energy, in accordance with some implementations. For example, a rough fit, in various implements discussed herein, gives a good initial fit. There may be issues with portions of the fit. For example, when fitting a shirt onto a dog avatar, the collar bone of the shirt may not fit very well onto the neck of the dog. Method 1300 may begin at block 1302.

At block 1302, Laplacian regularization is used to improve the fit of the garment onto the target avatar. Laplacian regularization is a graph-based regularization technique that encourages similar function values or parameters for connected nodes in a graph, promoting smoothness and borrowing strength from neighboring data points. Laplacian regularization uses a Laplacian matrix obtained from a graph representing relationships between data points (like categorical feature values or gene interactions) to add a penalty term to a model's objective function.

This helps improve model generalization, handles missing data by using information from known neighbors, and can be applied in various fields like semi-supervised learning, neural networks, and image processing. Laplacian regularization may include graph construction, a Laplacian matrix, a regularization term, and model training. Block 1302 may be followed by block 1304.

At block 1304, as conformal as possible (ACAP) regularization is used to improve the fitting of the garment onto the target avatar. ACAP regularization is a technique, rooted in differential geometry, that aims to preserve local angles during a geometric transformation, such as surface registration or volumetric mapping. ACAP regularization quantifies and penalizes deviations from ideal conformal (angle-preserving) mappings, permitting flexibility in local scale while maintaining mesh structure and geometry. This method is applied in computer graphics, shape modeling, and the design of metamaterials to ensure high-fidelity deformations.

ACAP regularization preserves angles, balances conformality and other constraints, and provides for flexibility in scale. ACAP regularization may use conformal mapping, regularization, and ACAP deformation loss. ACAP regularization may be used to have minimal/reduced triangle deformation. Together, the Laplacian regularization and the ACAP regularization may be followed by block 1304.

At block 1306, strain energy is reduced. As discussed above, reducing a strain energy may be performed using Laplacian regularization, as conformal as possible (ACAP) regularization, or a combination of these techniques. Laplacian regularization and ACAP regularization are only non-limiting examples, and it is also possible to use other regularization techniques.

By reducing strain energy, the quality of an initial rough fit may be improved. The two provided regularization techniques improve different aspects of the fit. As noted, optimizing Laplacian regularization may make the deformation smoother and ACAP regularization minimizes/reduces triangle deformation. Together, these metrics minimize/reduce strain and bending energy.

For a virtual accessory in a computer graphics or simulation environment, strain energy is the internal potential energy stored within the virtual object as the virtual object deforms. Bending energy is a specific component of this total strain energy that resists changes in the object's curvature. These energies are concepts in physically based simulation, which aims to model realistic and plausible movements for virtual objects.

Strain energy is computed based on how the accessory's mesh is deformed from its original, undeformed shape. Based on the calculated strain energy, the physics engine generates internal restoring forces. These forces act to pull the accessory back toward its original shape, preventing the accessory from deforming indefinitely and giving the accessory a spring-like, elastic quality. Hence, minimizing/reducing strain energy provides a better fit for the garment, in that this minimizes/reduces forces incident on the accessory that may otherwise deform the accessory from a good fit onto the target avatar.

FIG. 14 is a block diagram that illustrates an example computing device which may be used to implement one or more features described herein, in accordance with some implementations. In one example, computing device 1400 may be used to implement a computer device (e.g., server 102 and/or client device 110 of FIG. 1) and/or other devices usable in the system architecture 100, and to perform appropriate method implementations described herein. Computing device 1400 can be any suitable computer system, server, or other electronic or hardware device. For example, the computing device 1400 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1400 includes a processor 1402, a memory 1404, input/output (I/O) interfaces 1406, and audio/video input/output devices 1414. At least some of the various components of FIG. 14 as described herein may correspond to analogous components in FIG. 1 (e.g., the I/O interface 1406 and the I/O interface 114/134, the virtual experience application 1410 and the virtual experience application 112/132, etc.).

Processor 1402 can be one or more processors and/or processing circuits to execute program code and control basic operations of the computing device 1400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1404 is typically provided in computing device 1400 for access by the processor 1402, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 1402 and/or integrated therewith. Memory 1404 can store software operating on the computing device 1400 by the processor 1402, including an operating system 1408, a virtual experience application 1410, an accessory adaptation application 1412, and other applications (not shown). In some implementations, virtual experience application 1410 and/or accessory adaptation application 1412 can include instructions that enable processor 1402 to perform the functions (or control performance of the functions) described herein (e.g., some or all of the operations of the methods described with respect to FIGS. 8-9 and 11-13, and/or other operations described herein).

For example, virtual experience application 1410 can include an accessory adaptation application 1412, which as described herein can adapt fitting of accessories within an online virtual experience server (e.g., server 102). Elements of software in memory 1404 can alternatively be stored on any other suitable storage location or computer-readable medium. In addition, memory 1404 (and/or other connected storage device(s)) can store instructions and data used in the features described herein. Memory 1404 and any other type of storage (magnetic disk, optical disk, magnetic tape, or other tangible media) can be considered “storage” or “storage devices.”

I/O interface(s) 1406 can provide functions to enable interfacing the computing device 1400 with other systems and devices. For example, network communication devices, storage devices (e.g., memory and/or data store 120), and input/output devices can communicate via I/O interface(s) 1406. In some implementations, the I/O interface(s) 1406 can connect to interface devices including input devices (keyboard, pointing device, touchscreen, microphone, camera, scanner, etc.) and/or output devices (display device, speaker devices, printer, motor, etc.).

The audio/video input/output devices 1414 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 14 shows one block for each of processor 1402, memory 1404, I/O interface(s) 1406, and software blocks of operating system 1408, virtual experience application 1410, and accessory adaptation application 1412. These blocks may represent one or more processors or processing circuitries, operating systems, memories, I/O interfaces, applications, and/or software engines. In other implementations, computing device 1400 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the computing device 1400 (e.g., processor(s) 1402, memory 1404, and I/O interface(s) 1406). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 1414, for example, can be connected to (or included in) the computing device 1400 to display images pre- and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device (e.g., voice output or synthesis that speaks text).

One or more methods described herein (e.g., methods 800, 900, 1100, 1200a, 1200b, and 1300) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to fit a garment onto a target avatar, the method comprising:
obtaining garment information, the garment information including a plurality of garment vertices, a respective garment skinning weight for each vertex of the plurality of garment vertices, and a skeletal structure associated with the garment that defines source bones associated with the garment;
obtaining target avatar information, the target avatar information including a plurality of target avatar vertices, a respective target avatar vertex skinning weight for each vertex of the plurality of target avatar vertices, and a skeletal structure of the target avatar that defines target bones of the target avatar;
grouping the plurality of garment vertices into a plurality of garment vertex clusters corresponding to the source bones based on the garment vertex skinning weights;
grouping the plurality of target avatar vertices into a plurality of target avatar vertex clusters corresponding to the target bones based on the target avatar vertex skinning weights;
initializing optimization matrices for the source bones associated with the garment and the target bones of the target avatar used to fit the garment onto the target avatar, wherein the optimization matrices define transformations that include pose rotations that cause vertices in garment vertex clusters to map to corresponding vertices in corresponding target avatar vertex clusters;
after initializing the optimization matrices, updating the optimization matrices by performing at least one of:
modifying the optimization matrices based on a first loss function calculated from aligning vertices in garment vertex clusters with corresponding vertices in target avatar vertex clusters; and
modifying the optimization matrices based on a second loss function calculated from regularization based on centroids of bones of the garment vertex clusters and centroids of corresponding bones of the target avatar vertex clusters; and
after updating the optimization matrices, fitting the garment onto the target avatar using the optimization matrices.

2. The computer-implemented method of claim 1, wherein the skeletal structure associated with the garment has a same morphology as the skeletal structure of the target avatar.

3. The computer-implemented method of claim 1, wherein the skeletal structure associated with the garment has a different morphology as the skeletal structure of the target avatar.

4. The computer-implemented method of claim 1, further comprising, after the fitting, causing the target avatar to be displayed, wherein the target avatar is depicted as wearing the garment.

5. The computer-implemented method of claim 1, wherein initializing the optimization matrices causes a front of the garment to correspond to a front of the target avatar.

6. The computer-implemented method of claim 1, wherein aligning the vertices in the garment vertex clusters with corresponding vertices in the target avatar vertex clusters based on the first loss function comprises aligning the vertices in the garment vertex clusters onto corresponding vertices in the target vertex avatar clusters using one or more of rotation, scale, or shear transformations.

7. The computer-implemented method of claim 1, wherein the first loss function is a chamfer loss function calculated as a sum of squared Euclidean distances from vertices in the garment vertex clusters to corresponding nearest neighbors in the target avatar vertex clusters and squared Euclidean distances from vertices in the target avatar vertex clusters to corresponding nearest neighbors in the garment vertex clusters.

8. The computer-implemented method of claim 1, wherein the second loss function is a point-to-point loss function calculated based on absolute differences between vertices in the garment vertex clusters and corresponding vertices in the target avatar vertex clusters.

9. The computer-implemented method of claim 1, wherein grouping the plurality of garment vertices into corresponding garment vertex clusters comprises, for source bones in the garment, adding garment vertices to garment vertex clusters corresponding to given source bones in response to determining that a respective skinning weight for a garment vertex with respect to a given source bone is greater than zero.

10. The computer-implemented method of claim 1, wherein grouping the plurality of target avatar vertices into corresponding target avatar vertex clusters comprises, for target avatar bones in the target avatar, adding target avatar vertices to target avatar vertex clusters corresponding to given target bones in response to determining that a respective skinning weight for a target avatar vertex with respect to a given target bone is greater than zero.

11. The computer-implemented method of claim 1, wherein updating the optimization matrices is performed iteratively two or more times, and wherein the updating is continued until a value of the first loss function is less than a first threshold value, a value of the second loss function is less than a second threshold value, or a combination thereof.

12. The computer-implemented method of claim 1, wherein updating the optimization matrices is performed iteratively two or more times, and wherein the updating is continued until a computational budget for updating is exhausted, until a change in values of the optimization matrices between consecutive iterations falls below a threshold, or a combination thereof.

13. The computer-implemented method of claim 1, further comprising using Laplacian regularization, as conformal as possible regularization, or a combination thereof to reduce a strain energy associated with fitting the garment onto the target avatar.

14. The computer-implemented method of claim 1, wherein fitting the garment onto the target avatar using the optimization matrices comprises applying the optimization matrices as affine transformations to map the source bones associated with the garment to the target bones of the target avatar.

15. A non-transitory computer-readable medium with instructions stored thereon that, responsive to execution by a processing device, causes the processing device to perform operations or control the performance of operations to fit a garment onto a target avatar, the operations comprising:
obtaining garment information, the garment information including a plurality of garment vertices, a respective garment skinning weight for each vertex of the plurality of garment vertices, and a skeletal structure associated with the garment that defines source bones associated with the garment;
obtaining target avatar information, the target avatar information including a plurality of target avatar vertices, a respective target avatar vertex skinning weight for each vertex of the plurality of target avatar vertices, and a skeletal structure of the target avatar that defines target bones of the target avatar;
grouping the plurality of garment vertices into a plurality of garment vertex clusters corresponding to the source bones based on the garment vertex skinning weights;
grouping the plurality of target avatar vertices into a plurality of target avatar vertex clusters corresponding to the target bones based on the target avatar vertex skinning weights;
initializing optimization matrices for the source bones associated with the garment and the target bones of the target avatar used to fit the garment onto the target avatar, wherein the optimization matrices define transformations that include pose rotations that cause vertices in garment vertex clusters to map to corresponding vertices in corresponding target avatar vertex clusters;
after initializing the optimization matrices, updating the optimization matrices by performing at least one of:
modifying the optimization matrices based on a first loss function calculated from aligning vertices in garment vertex clusters with corresponding vertices in target avatar vertex clusters; and
modifying the optimization matrices based on a second loss function calculated from regularization based on centroids of bones of the garment vertex clusters and centroids of corresponding bones of the target avatar vertex clusters; and
after updating the optimization matrices, fitting the garment onto the target avatar using the optimization matrices.

16. The non-transitory computer-readable medium of claim 15, wherein the first loss function is a chamfer loss function calculated as a sum of squared Euclidean distances from vertices in the garment vertex clusters to corresponding nearest neighbors in the target avatar vertex clusters and squared Euclidean distances from vertices in the target avatar vertex clusters to corresponding nearest neighbors in the garment vertex clusters.

17. The non-transitory computer-readable medium of claim 15, wherein the second loss function is a point-to-point loss function calculated based on absolute differences between vertices in the garment vertex clusters and corresponding vertices in the target avatar vertex clusters.

18. A system comprising:
a memory with instructions stored thereon; and
a processing device, coupled to the memory, the processing device configured to access the memory and execute the instructions, wherein the instructions cause the processing device to perform operations or control the performance of operations to fit a garment onto a target avatar, the operations comprising:
obtaining garment information, the garment information including a plurality of garment vertices, a respective garment skinning weight for each vertex of the plurality of garment vertices, and a skeletal structure associated with the garment that defines source bones associated with the garment;
obtaining target avatar information, the target avatar information including a plurality of target avatar vertices, a respective target avatar vertex skinning weight for each vertex of the plurality of target avatar vertices, and a skeletal structure of the target avatar that defines target bones of the target avatar;
grouping the plurality of garment vertices into a plurality of garment vertex clusters corresponding to the source bones based on the garment vertex skinning weights;
grouping the plurality of target avatar vertices into a plurality of target avatar vertex clusters corresponding to the target bones based on the target avatar vertex skinning weights;
initializing optimization matrices for the source bones associated with the garment and the target bones of the target avatar used to fit the garment onto the target avatar, wherein the optimization matrices define transformations that include pose rotations that cause vertices in garment vertex clusters to map to corresponding vertices in corresponding target avatar vertex clusters;
after initializing the optimization matrices, updating the optimization matrices by performing at least one of:
modifying the optimization matrices based on a first loss function calculated from aligning vertices in garment vertex clusters with corresponding vertices in target avatar vertex clusters; and
modifying the optimization matrices based on a second loss function calculated from regularization based on centroids of bones of the garment vertex clusters and centroids of corresponding bones of the target avatar vertex clusters; and
after updating the optimization matrices, fitting the garment onto the target avatar using the optimization matrices.

19. The system of claim 18, wherein the first loss function is a chamfer loss function calculated as a sum of squared Euclidean distances from vertices in the garment vertex clusters to corresponding nearest neighbors in the target avatar vertex clusters and squared Euclidean distances from vertices in the target avatar vertex clusters to corresponding nearest neighbors in the garment vertex clusters.

20. The system of claim 18, wherein the second loss function is a point-to-point loss function calculated based on absolute differences between vertices in the garment vertex clusters and corresponding vertices in the target avatar vertex clusters.
